(19) United States
(12) Patent Application Publication
(10) Pub. No.: US 2003/0172127 A1
(43) Pub. Date: Sep. 11, 2003

(54) Execution of process by references to directory service

(76) Inventors: Charles J. Northrup, Old Bridge, NJ (US); Franklin J. Angel, Mount Laurel, NJ (US)

Correspondence Address: ELMAN TECHNOLOGY LAW, P.C., P O BOX 209, SWARTHMORE, PA, 19081-0209, US

(21) Appl. No.: 10/068,077

(22) Filed: Feb. 6, 2002

(51) Int. Cl. G06F 15/16

(52) U.S. Cl. 709/219

(57) ABSTRACT

Service registration, discovery, connectivity, and administration are provided on a computer network. The invention includes a directory service, a service provider service, and a consumer provided service. A first software component registers as a service with a directory service process executing on a second computer, and the directory service process creates a registration for the first component of software. A second component of software executes on a third computer and communicates to the directory service process, a request to access and interact with the first software component. The directory service process responds by locating the registration entry for the first component of software, and facilitates communication with the first component of software on behalf of the second component of software. Services may include software engine service, authentication service, generic front end loading service, payment connection service, a data sharing service, medical test results reporting service, data store forwarding service, physician pharmaceutical service, academic transcript service, public office election service, medical records service, resume matching service, company credit reporting service, a prepay service, translation service, and an environment service.

### COPYRIGHT AUTHORIZATION

A portion of the disclosure of this patent document contains material which is subject to copyright protection. The copyright owner has no objection to the facsimile reproduction by anyone of the patent disclosure, as it appears in the PTO patent file or records, but otherwise reserves all copyright rights whatsoever.

### BACKGROUND OF THE INVENTION

1. Field of the Invention

This invention relates to a network and provides a means for a user to provide a service, to consume a service, and to access and interact with a multiplicity of services.

2. Description of Related Art

The Internet and the World Wide Web have grown in size and complexity since inception. A common activity is to use a graphic rendering program such as Microsoft Internet Explorer, Netscape Navigator, Opera, or even Microsoft Word, to request and graphically render a Hypertext Markup Language (HTML) document. In requesting the HTML document, the user indicates a Uniform Resource Identifier (URI) to the graphic rendering process.

The following terms are defined in: “Hypertext Transfer Protocol—HTTP/1.1, RFC 2616 Fielding, et al.” One who is not skilled in the state of the art is encouraged to read the reference for clarity on the subject manner.

URI—Uniform Resource Identifier. The generic set of all names/addresses that are short strings that refer to resources.

URL—Uniform Resource Locator. An informal term (no longer used in technical specifications) associated with popular URI schemes: http, ftp, mailto, etc.

URN—Uniform Resource Name. A URN is an URI that has an institutional commitment to persistence, availability, etc. Note that this sort of URI may also be a URL. See, for example, PURLs. A particular scheme, urn:, specified by RFC2141 and related documents, intended to serve as persistent, location-independent, resource identifiers.

The “http” scheme is used to locate network resources via the HTTP protocol. This section defines the scheme-specific syntax and semantics for http URLs.

http_URL=“http:”“//”host[“:”port][abs_path[“?”query]]

If the port is empty or not given, port 80 is assumed. The semantics are that the identified resource is located at the server listening for TCP connections on that port of that host, and the Request-URI for the resource is abs_path (section 5.1.2). The use of IP addresses in URLs SHOULD be avoided whenever possible (see RFC 1900 [24]). If the abs_path is not present in the URL, it MUST be given as “/” when used as a Request-URI for a resource (section 5.1.2). If a proxy receives a host name which is not a fully qualified domain name, it MAY add its domain to the host name it received. If a proxy receives a fully qualified domain name, the proxy MUST NOT change the host name.

By way of example, but not limitation, the user can enter an http schema URL such as:

http://www.gtlinc.com/products.html

In this example, the user is requesting the products.html document from the server given as www.gtlinc.com.

To retrieve the HTML document, the server must be running a Hypertext Transfer Protocol daemon (HTTPD) such as Apache from http://www.apache.org, or equivalent thereof. The HTTPD executes on a service provider system and listens for request on a port, typically port 80, which is a well-known, industry standard port, for the HTTP daemon. By using a standard port, a person can indicate to the Netscape Navigator, or equivalent thereof, to request an http document via a given Uniform Resource Location (URL). By having the standard port 80 used, anybody can request the URL since they do not have to worry about what port the HTTP Daemon is listening on. Otherwise, the user would have to indicate the desired port, such as http://www.gtlinc.com:399, where :399 indicates to connect on port 399. Using the industry standard port simplifies the data entry and the ability to access Hypertext Markup Language (HTML) documents.

A user of a computer system (or somebody on behalf of the user) pays for access to the Internet through an Internet Service Provider (ISP), such as AT&T WorldNet, America On-Line, or Microsoft Network. In a typical situation, the ISP frequently blocks request to port 80 on the user computer system to prevent the user from running a web site via an HTTP Daemon on their home computer, on the well known port 80. The user could provide the HTTP Daemon on a different port, such as port 399, but nobody would know to access that port unless the user published the port number. Even in publishing the port number, the enormous potential audience would unlikely see the advertisement.

Another challenge for the user accessing the Internet through an ISP, is that the ISP frequently uses Dynamic Addressing. In such circumstances, an Internet Address is assigned only when the user connects to the Internet through the ISP. When the user disconnects, then the IP address will be reassigned to a different user. This poses a problem in publishing the alternative HTTP Daemon running on port 399 since the Internet Address changes each time the user access the Internet. Even cable modem providers frequently use dynamic internet addressing. In some cases though, a cable modem ISP may offer a dedicated Internet Address, but still frequently blocks port 80 on the user computer. In some cases, the ISP requires the user of the ISP service to enter an agreement wherein the user is precluded from running a service on port 80. Even if the user were to publish the current dynamic Internet address, they could only do so via publishing the physical address such as 190.190.83.2 and potentially the corresponding port. In any case, the user does not have a domain name associated with their computer such as gtlinc.com, wherein they could publish the domain name, which is easier for a prospect visitor to remember.

Although the problem of port blocking and dynamic Internet Address assignment frequently affects a user of an ISP service, similar challenges are faced by the industry in general. By way of example, but not limitation, a computer provider, a software provider, a tax service provider, a news service, a stock broker, a sales person selling goods or services, and others offering goods or services, are limited to providing the HTTP Daemon on port 80 because it is the industry standard port for the HTTP daemon. If any of the aforementioned wished to provide an alternative service on a port other than port 80, they would have to undertake a massive marketing campaign to educate potential visitors (users or businesses requesting information) on the particular port number.

The industry currently has products and services for providing directory services, but the directory service is generally limited to the enterprise within which the directory service is executing. By way of example, the Sun Microsystems iPlanet Directory Service is sold as a light weight directory access protocol for administering directory services within the enterprise. Even at that, Sun marketing information indicates the iPlanet Directory Service as primarily for user administration within the enterprise. It does not provide a solution or function effectively for the global network. It does not provide a solution or function effectively for the Internet.

Industry members such as IBM, Microsoft, Hewlett Packard, SAP, and even Sun Microsystems have been indicating the Universal Definition Discovery Interchange (UDDI) as a means for providing information on service providers. The UDDI Specification, (available on-line at http://www.uddi.org) however, does not indicate registration of information such as other than port 80.

A more generalized solution for accessing and interacting with services provided on the Internet is needed.

It is therefore an object of this invention to provide methods and systems for accessing and interacting with a multiplicity of services.

The use of a service often will require payment for the services rendered. The standard method of providing credit card payment over the Web is viewed as insecure and tedious. A user completes a form displayed through the graphic rendering process and uses a pointing device such as a mouse to “click” on a graphical representation indicating to send the content of the user provided information to the service provider.

The Microsoft Corporation recently announced their Passport implementation wherein a user subscribes to the Microsoft Passport service, provides credit card information such as card type, card number, expiration date, card holder, billing address, and possible other information such as shipping address. The disadvantage of the Microsoft Passport implementation is that Microsoft controls that information. By way of example, the subscriber payment information is maintained on a computer system administered by Microsoft. The data set that Microsoft maintains may be propagated to other servers as needed. While Microsoft claims the method to be secure, the disadvantage is that by having a centralized data set containing payment information for an enormous number of subscribers, would make that centralized data set a computer cracker's main target.

An alternative implementation is being proposed by Sun Microsystems under their Liberty Alliance consortium. Numerous members such as Mastercard, VISA, American Express, and others have signed up for the Liberty Alliance. The downside of the Liberty Alliance implementation is that as of today, the implementation is not yet defined. Furthermore, the indications are that they will still transmit credit card payment information to port 80 of the service provider providing the service (i.e., sale of service or goods is still a service). Sun Microsystems currently offers the Java Wallet, which is a family of products written in the Java programming language that are designed to enable secure commerce operations.

An alternative payment mechanism is provided by PayPal, which is used quite frequently for auction sites such as www.ebay.com. The PayPal implementation, however, requires PayPal to act in the capacity of a credit card merchant. Therefore a buyer provides PayPal with credit card information and PayPal charges the credit card and receives payment. PayPal then credits the seller's account with the appropriate amount. A second disadvantage is that PayPal charges a transaction fee which is then deducted from the seller's amount. A third disadvantage is that both the buyer and the seller must provide account information, which is then maintained by PayPal.

It is understood that a user of a computer system could cause a process to execute wherein the process can provide payment information to a requesting process. The disadvantage is that there is no mechanism for verifying whom the requesting process is executing on behalf of. In this case, the user process could provide payment information to anybody, including a computer hacker, and thus is unacceptable.

It is therefore another object of this invention to provide methods and systems for payment of services.

In the current state of the computing industry, a user who desires to access a web page, but, who does not know the corresponding URI, must use a browser such as Microsoft Internet Explorer to visit a search engine such as Yahoo or Google and submit keywords to query for pages satisfying their request. The user is then presented with one or more URIs and text descriptions of the content at the URI. The user can then “click” on one of the URIs satisfying the request. The corresponding HTML document is then retrieved and rendered for the user to see. A disadvantage is that the user must undergo a two-step approach. First, the user must visit Google, enter the terms, and then “click” on the desired URI.

It is therefore another object of this invention to provide methods and systems for simplifying connections.

An alternative is provided by RealNames. RealNames allows a corporation, such as Global Technologies Ltd., Inc., to register a keyword GTL so that when a user enters GTL as the desired site, the RealName would be translated to http://www.gtlinc.com. The challenge, of course, is that the user must know the keyword.

### SUMMARY OF THE INVENTION

According to the present invention, a method for using a service in a computer network a first software component executes on a first computer. The first software component registers as a service with a directory service process executing on a second computer, and the directory service process creates a registration for the first component of software. A second component of software executes on a third computer and communicates to the directory service process, a request to access and interact with the first software component. The directory service process responds by locating the registration entry for the first component of software, and facilitates communication with the first component of software on behalf of the second component of software.

### BRIEF DESCRIPTION OF THE DRAWINGS AND LISTINGS

FIG. 1 is a diagram of a computer network communicating according to the present invention.

FIGS. 2-7 are flow charts of the operation of the present invention.

FIG. 2 is a flowchart of a directory service connection service.

FIG. 3 is a flowchart of a directory service use.

FIG. 4 is a flowchart of a service provider registration.

FIG. 5 is a flowchart of a service registration.

FIG. 6 is a flowchart of a consumer registration.

FIG. 7 is a flowchart of a consumer request for service.

FIGS. 8-13 are diagrams showing the communications relationships of different types of data providers in accordance with the present invention.

FIG. 8 is a schematic block diagram of connectivity depicting horizontal partition by category.

FIG. 9 is a schematic block diagram of connectivity depicting horizontal partition by provider.

FIG. 10 is a schematic block diagram of connectivity depicting horizontal partition by activity.

FIG. 11 is a schematic block diagram of connectivity depicting horizontal partition by cost.

FIG. 12 is a schematic block diagram of connectivity depicting horizontal partition by protocol.

FIG. 13 is a schematic block diagram of connectivity depicting horizontal partition by entity type.

FIGS. 14-16 are diagrams depicting data transfer provided by a directory service.

FIG. 14 is a diagram depicting a sample TDS with three service directories according to the present invention.

FIG. 15 is a diagram depicting a sample environment with five systems sharing TDS information according to the present invention.

FIG. 16 is a diagram depicting a sample TDS configuration as applied to directories provided through the Sun Solaris 2.7 operating system according to the present invention.

The program listings are as follows:

Program Listing 1.1 source code listing of one implementation for the replacement recv function

Program Listing 2.0 Engine Service engine.c

Program Listing 2.1 Engine Service getnvpair.c

Program Listing 2.2 Engine Service authorize.c: placeholder authorization service

Program Listing 2.3 Engine Service input.c: placeholder input service

Program Listing 2.4 Engine Service postprocess.c: placeholder postprocess service

Program Listing 2.5 Engine Service preprocess.c: placeholder preprocess service

Program Listing 2.6 Engine Service process.c: placeholder process service

Program Listing 2.7 Engine Service response.c: placeholder response service

Program Listing 2.8 Engine Service readline.c:

Program Listing 2.9 Engine Service wait_read.c

Program Listing 2.10 Engine Service—peek.c

Program Listing 2.11 Engine Service peek_c.c

Program Listing 2.12 Engine Service main.c

Program Listing 2.13 Engine Service—Makefile

Program Listing 2.14 Engine Service—engine.mk

Program Listing 2.15 Engine Service—dummy.mk

Program Listing 2.16 Engine Service—engine.conf

Program Listing 3.0 authentication service—authenticate.c

Program Listing 3.1 Authentication Service—log.h

Program Listing 3.2 Authentication Service—tds2.h

Program Listing 3.3 Authentication Service—makefile

Program Listing 3.4 authentication Service—authenticate.conf

Program Listing 4.1—Thread Directory Service—tds3.c

Program Listing 4.2—Thread Directory Service—ste.c

Program Listing 4.3—Thread Directory Service—log.c

Program Listing 4.4 Thread Directory Service—ic.c

Program Listing 4.5 thread directory service—set_blocking.c

Program Listing 4.6 thread directory service—set_nonblocking.

Program Listing 4.7 thread directory service—Makefile

Program Listing 5.0 fopenc service—fopen.c

Program Listing 6.0 fscanf service—fscanf.c

Program Listing 7.0 fclose service—fclose.c

Program Listing 8.0 caps service caps.c

Program Listing 9.1 generic front end loader service gfel.c

Program Listing 9.2 generic front end loader service client_gl.c

Program Listing 9.3 generic front end loader service client_gl2.c

Program Listing 9.4 generic front end loader service gl3.c

Program Listing 10.1 thread connection service—talk2.c

Program Listing 10.2 thread connection service—participant.c

Program Listing 10.3 thread connection service—tcp_accept2.c

Program Listing 10.4 thread connection service—tcp_connect.c

Program Listing 10.5 thread connection service—tcp_listen.c

Program Listing 11.1 supporting functions—reaper.c

Program Listing 12.1 supporting service—cat_service.c

Program Listing 12.2 supporting service—echo_service.c

Program Listing 12.3 supporting service—daytime_service.c

Program Listing 12.4 supporting service—ksh_service.c

Program Listing 12.5 mail service—mail_service.c

Program Listing 13.1 TDS supporting functions—tds_query_p.c

Program Listing 13.2 TDS supporting functions—tds_register_p.c

Program Listing 13.3 TDS supporting functions—getdtscinfo.c

Program Listing 13.4 TDS supporting functions—tds.c

Program Listing 14.0 process function—cps.c

Program Listing 14.1 process function—cps2.c

Program Listing 14.2 process function—cps3.c

Program Listing 15.0 stateful service—main.c

Program Listing 15.1 stateful service—tcp_accept.c

Program Listing 15.2 stateful service—tcp_listen.c

Program Listing 15.3 stateful service—getaddrinfo.c

Program Listing 16.1—File SERVICES1 Service prototype table.

Program Listing 16.2—File SERVICES2 Service prototype table.

Program Listing 16.3—File SERVICES3 Service prototype table.

Program Listing 16.4—Command line to generate data dictionary from prototype table

Program Listing 16.5—Generated Data Dictionary

Program Listing 16.6—Services2 prototype table

Program Listing 16.7—Generated Data Dictionary for Services2

Program Listing 16.8—Providers prototype table

Program Listing 16.9—Providers generated data dictionary

Program Listing 16.10—Cymbal instructions to insert record

Program Listing 16.11—Cymbal instructions to report registration entry information

Program Listing 16.12—Global Definitions

The Architecture

The Internet is a network linking computer systems together and communicating via a standard protocol. A computer network is simply a collection of autonomous computers connected together to permit sharing of hardware and software resources, and to increase overall reliability. The qualifying term “local area” is usually applied to computer networks in which the computers are located in a single building or in nearby buildings, such as on a college campus or at a single corporate site. When the computers are further apart the term “wide area network” may be used.

As computer networks have developed, various approaches have been used in the choice of communication medium, network topology, message format, protocols for channel access, and so forth. Some of these approaches have emerged as de facto standards, but there is still no single standard for network communication. The Internet is a continually evolving collection of networks, including Arpanet, NSFnet, regional networks, local networks at a number of university and research institutions, a number of military networks, and increasing, various commercial networks. The protocols generally referred to as TCP/IP were originally developed for use through Arpanet and have subsequently become widely used in the industry. The protocols provide a set of services that permit processes to communicate with each other across the entire Internet.

A computer can be a mainframe, minicomputer, microcomputer, or any of a number of other computing devices. In the case of the present invention, the computer should be able to communicate with the outside world. Therefore, for example, a first generation microwave oven controller using a Z-80 chip would not be able to use the invention, but it is conceivable that providing a communications capability to a microwave controller would enable it to use the invention. A number of different computing devices are able to communicate with the outside world while computing. Such devices include set top boxes, PDAs (personal digital assistants), and cellular phones using CDMA or similar technologies.

Likewise, a server is traditionally at a fixed location; however it is possible to provide a server in any of a number of forms. The server can be running as a client of another server and in fact it is often the case that a computing device may be a client to another device which functions as a host, and yet perform server functions for that other device.

A model for network architectures has been proposed and widely accepted. It is known as the International Standards Organization (ISO) Open Systems Interconnection (OSI) reference model. The OSI reference model is not itself a network architecture. Rather it specifies a hierarchy of protocol layers and defines the function of each layer in the network. Each layer in one computer of the network carries on a conversation with the corresponding layer in another computer with which communication is taking place, in accordance with a protocol defining the rules of this communication. In reality, information is transferred down from layer to layer in one computer, then through the channel medium and back up the successive layers of the other computer. However, for purposes of design of the various layers and understanding their functions, it is easier to consider each of the layers as communicating with its counterpart at the same level, in a “horizontal” direction. (See, e.g. The TCP/IP Companion, by Martin R. Arick, Boston: QED Publishing Group 1993, and U.S. Pat. No. 5,159,592. These, and all patents and publications referenced herein, are hereby incorporated by reference.)

The lowest layer defined by the OSI model is called the “physical layer,” and is concerned with transmitting raw data bits over the communication channel. Design of the physical layer involves issues of electrical, mechanical or optical engineering, depending on the medium used for the communication channel. The second layer, next above the physical layer, is called the “data link” layer. The main task of the data link layer is to transform the physical layer, which interfaces directly with the channel medium, into a communication link that appears error-free to the next layer above, known as the network layer. The data link layer performs such functions as structuring data into packets or frames, and attaching control information to the packets or frames, such as checksums for error detection, and packet numbers.

The Internet Protocol (IP) is implemented in the third layer of the OSI reference model, the “network layer,” and provides a basic service to TCP: delivering datagrams to their destinations. TCP simply hands IP a datagram with an intended destination; IP is unaware of any relationship between successive datagrams, and merely handles routing of each datagram to its destination. If the destination is a station connected to a different LAN, the IP makes use of routers to forward the message.

The basic function of the Transmission Control Protocol (TCP) is to make sure that commands and messages from an application protocol, such as computer mail, are sent to their desired destinations. TCP keeps track of what is sent, and retransmits anything that does not get to its destination correctly. If any message is too long to be sent as one “datagram,” TCP will split it into multiple datagrams and makes sure that they all arrive correctly and are reassembled for the application program at the receiving end. Since these functions are needed for many applications, they are collected into a separate protocol (TCP) rather than being part of each application. TCP is implemented in the “transport layer,” namely the fourth layer of the OSI reference model.

Except as otherwise is evident from the context, the various functions of the present invention reside above the transport layer of the OSI model. The present invention may be used in conjunction with TCP/IP at the transport and network layers, as well as with any other protocol that may be selected.

The OSI model provides for three layers above the transport layer, namely a “session layer,” a “presentation layer,” and an “application layer,” but in the Internet these theoretical “layers” are undifferentiated and generally are all handled by software.

Internet Firewall

A security system placed between the Internet and an organization's network (such as a LAN) to provide a barrier against security attacks. Internet firewalls typically operate by monitoring incoming and/or outgoing traffic to/from the organization's network, and by allowing only certain types of messages to pass. For example, a firewall may be configured to allow the passage of all TCP/IP traffic addressed to port 80, and to block all other traffic. For more information of Internet Firewalls, see Chapman and Zwicky, Building Internet Firewalls, O'Reilly publishing, 1995 (ISBN 1-56592-124-0).

Computer systems having access to the Internet, can have a dynamic Internet Address assigned to them. The Internet Firewall can be configured to perform network address translation as defined in “Network Working group Request for Comments 1631, and Request for Comments 3022.”

A computer system having access to the Internet can be assigned a private Internet Address, as defined in Request For Comments 1597.

Component of Software

A basic principle of the invention is that of a component of software. The term component of software is deliberately chosen to indicate that less then an executable program may be used. By way of example, but not limitation, a component of software can be:

an executable program

an executable program linked with shared libraries, dynamic link libraries, or other such libraries as would be provided for in an embodiment

an object as one would understand in using remote procedure call

an object as one would understand in using the Microsoft Component Object Model or other such industry standard

a dynamically loadable module such as a module in a shared library (also called dynamic link library on Microsoft Windows) or other such library as defined by the operating system or embodiment

a function that is called by a dynamically loadable library initialization function, such as occurs with the use of a Microsoft's Windows DLL. In such cases, a DllMain function may be called when a thread (either a process, or a thread created by the process) attaches to the library. Initialization functions are also accessible through KornShell and other such processes. The initialization function may therefore perform the functionality required of the component of software

a software assembly as defined in the Microsoft C# Language

a builtin function of a shell program such as the KornShell

a function of an interpretive language processing element, such as a KornShell function, shell function, or a perl function.

a shell script as defined by a shell program such as the KornShell or other interpretive language processing element.

a script that is interpreted by another process such as that which is used by BASIC, Kornshell, Csh, Tcsh, Perl, Tcl/Tk, or other such interpreter

a module which is then linked into an executable with a just-in-time compiler

a byte stream which is communicated to an interpreter such as that which is available with KornShell, Java

a data stream which is communicated to an interpreter process

Note that when used with the invention, the component of software may require the use of a generic front end loader process that initializes an address space. By way of example, but not limitation such a generic front end loader could:

accept command line parameters identifying the component of software to be used, or

determine such information by accessing a configuration, or

accessing a memory location accessible to the generic front-end loader, or

communication with a second process providing such information, or

accessing and interacting with a directory service process, or

accessing and interacting with a component of software to determine such information, or

communicating with a second process to determine such information, or

use inter-process communications to determine such information, or

use intra-process communications to determine such information, or

use operating system interfaces providing such information, or

use an application programming interface to determine such information, or

use a combination of the above to determine such information.

Note that when the component of software is provided by a data stream interpreted by an interpreter, then the data stream may require a local process to communicate with an accessible process in order to facilitate the data stream. By way of example, but not limitation, such a data stream may be communicated from an Internet Address and Port as one would understand when using the socket application programming interface, or equivalent thereof. Alternative network Application Programming Interfaces can be used (See the discussion on communications for examples). Such an implementation would require connecting to the process at the specified network (which could include an Internet Address and port), possibly communicating a request to the connected process, and receiving a response wherein the response communication includes the data stream. Alternatively, by way of example, such a data stream may be communicated from a process accessible through communications over the Internet wherein the process is defined by a Universal Resource Location (URL) as in http://www.gtlinc.com/proc/stream or equivalent thereof.

A device driver can be used. Either one provided through the operating system interfaces, or, one provided by an application operating environment such as the AST ToolKit. By way of example, but not limitation, an implementation can use an open system call to open a device such that by accessing and interacting with the device, information such as that required for facilitating the methods, can be achieved. By way of example, a process issues:

fp=fopen(“directory service”, “rw”);

The process opens a device called directory service. As this may not be an operating system device, the fopen implementation determines how to access and interact with the device based on the device name specified. See function call and system calls for details on implementing augmented functions.

A component of software can be installed on the computer system, or accessible to the computer system through the network. A user, such as a consumer, or a service provider, can cause the software to be installed. This can include the use of software downloaded from the network, as well as software that is preinstalled on the computer system as purchased, or software that is installed during the installation of the operating system or component thereof. The component of software downloaded from the network may require an installation process to be executed, which then installs on the computer such that it can be executed. By way of example, but not limitation, a first component of software downloaded can be compressed and require decompression, resulting in an executable that then installs one or more components of software on the computer system. Examples would include such techniques as downloading an InstallShield package, a Java component, a C# Assembly or other such techniques as known in the industry.

One or more programming languages and programming techniques can be used to create various embodiments of the invention, and the invention can be implemented on various operating systems such as AIX, BSD, Linux, HP-UX, Solaris, UNIX, IRIX, OpenEdition, UnixWare, and Windows.

A component of software can provide a service for a daemon process listening on a particular network endpoint, such as Internet Address and port (i.e. 192.127.0.3 port 80). In such cases, the information communicated to the daemon process will be used by the daemon process to cause the service to be executed. According to U.S. Pat. No. 5,850,518, the service can be dynamically loaded, or can be executed in a manner in which the daemon process connects to the service via a communication link. Such cases may be necessary to provide the desired functionality.

Program Listing 15.0 through 15.3 provide an embodiment using a main program that accepts command line parameters indicating the type of primitive to use, the internet address and port, and the name of the service to load. The service is dynamically loaded from the libservices.so.1.0 library. Each time a connection is received, the service is invoked.

Application Service

An application is said to provide a primary service. The application may also offer one or more minor services. The primary service, along with any minor services, collectively constitute the application service. By way of example, an application such as the Netscape Communicator can provide a primary service of graphically rendering HTML documents. A minor service offered by the Netscape Communicator is a Messenger for administering (such as creating, sending, receiving, deleting, cataloging, viewing, forwarding, editing) electronic mail. A second minor service offered by the Netscape Communicator is a Composer for creating new HTML documents or editing existing documents. One skilled in the state of the art would understand that the a first user of an application could perceive the application as providing a primary service that is different from a second user of the same application.

Minor Service

A minor service provides some functionality towards the overall application service. The Minor Service is implemented through a component of software. When used in an active context, it is understood that the term Minor Service refers to the process executing the component of software. When used in the inactive context, the minor service refers to the component of software. Thus one would understand that a minor service is provided by a component of software and when the application requires interaction with the minor service, then the minor service is executing.

Service

A service is provided for by a component of software. A service may be a minor service, or a primary service. A service can be a primary service of a first application service, and a minor service of a second application service. A service can be a service to itself. By way of example, a service can be implemented as a first process which then issues a fork( ) system call to create a child process.

In standard UNIX environments, its it standard coding technique to create a daemon process listening for requests for services on a particular Internet Address and port. When a client connects to the specified port, then the daemon process will typically accept the connection, and then issue a fork function call. The fork function creates a child process. The original daemon process, called the parent process, remains executing. The child process typically closes its standard input, standard out, and standard error file descriptors. The child process then duplicates the file descriptor (or handle) associated with the accepted connection, as the new standard input, standard output, and standard error file descriptors. The child process then typically issues an exec function call. The exec function call overlays the image of the current process with a new image of a new executable program to be executed. The child process typically performs whatever action is necessary, and then exits.

There are cases, however, where the process providing the service may need to stay executing even after responding to the first requesting process. Different methods can be used. One method is for the first process to accept the connection, perform the desired service, and respond to the requesting process. In this manner, whatever state changes where made to the first process remain intact, and are available to subsequent processes. A second method is for the first process to create the child process, and to have the child process remain executing. In this manner, the changes made to the state of the child remain intact. For subsequent requesting processes to gain access to such state information, the child process provide means to permit the subsequent requesting process to access and interact with the child, which may include having the child connect to the requesting process, or, having the requesting process connect to the child, or both. An example of where such state information is useful to retain is when the service is to provide a function or system call on behalf of a requesting process. There are cases where the result of the function or system call must be retained by the service and accessible to subsequent requesting processes (which could be the same requesting process later accessing and interacting with the service). By way of example, a first requesting process sends a request to a service to perform a file open function call. The service perform the open function call and has associated therewith a file descriptor (or handle). The service provides the results to the requesting process. The requesting process then disconnects. A requesting process later accesses and interacts with the service, providing the service with the previous response indicating the results of the open function call. The requesting process provides a request indicating the service is to read a string from the file descriptor. The service, still having the file descriptor open, performs the read and returns the results thereof to the requesting process.

Application Process

The term application process, as used in this document, refers to the overall computer representation of the application service. In this definition, the term application process is defined to incorporate all processes of various “weight” including, but not limited to, heavy weight, medium weight, and light weight processes relating to the application service. A heavy-weight process executes in its own address space, whereas medium-weight and light-weight processes may execute within the same address space. The application process may constitute one or more of these processes. Each of these processes is said to have a thread of execution.

A thread, in this context, represents an execution stream of the application process. The notion of a thread can be provided by the underlying operating system, referred to as kernel-supported threads, or can be provided at the application level, referred to as user-level threads, or can be a mixture of the two. For the purposes of this description, these will collectively be referred to as threads. Note that in a distributed environment, one or more of these threads may be executing on a remote computer system.

The application process may be confined locally to the computer system on which the application process was initially started, or may have its execution threads distributed among various computer systems accessible to the computer system on which the application process was initially started.

When a user of the computer system requests to execute an application, a corresponding program is loaded into the computer's memory and a single thread of execution begins. This initial thread may then create additional threads on the local computer system, or possibly on a remote computer system, such as that which would occur with remote procedure call implementations, Microsoft COM, Microsoft DCOM, or other such industry standard techniques.

The creation of a new thread requires the starting point of the new thread to be specified. In procedural computer languages, for example, this would require the requesting thread to specify the address of the procedure to begin as a new thread.

Communication Devices

A computer system includes a communication device. By way of example, but not limitation, a communication device can be a modem, a network card, a RFC device, an infrared device, an optical device, a wireless device, a device connecting the computer to a public switching system device, such as that provided for by a telephone carrier, a T1 connection or equivalent thereof, or any such device for the purpose of facilitating communication between one or more computer systems. All such devices are referred to as communication devices.

A process can listen on a communication device, awaiting a communication. By way of example, but not limitation, a process can be considered a daemon process, such as that provided by inetd on a UNIX implementation, or other such process, and await a communication. When a communication is received, the process can accept the connection and then send communications, receive communications, or otherwise interact with the communication as appropriate.

A process that is listening on a communication device generally has a file descriptor open associated with the device. Certain embodiments, such as that with the Microsoft Windows operating system environment, can alternatively use a socket handle to listen on the device. Note, however, that with the U/WIN environment available from Global Technologies Ltd., Inc., the code would refer to a file descriptor that is then translated to a handle for the underlying operating system.

When a process accepts a connection, the process can cause a second process to begin executing. Alternatively, the second process may already be executing. In either case, the first process can inform the second process of the file descriptor, or handle, that the first process accepted the communication connection on. Various techniques are available to implement this. By way of example, but not limitation, the first process can cause the second process to be created and the file descriptor, or handle, can be inherited by the second process. Alternatively, the first process can open the second process and duplicate the handle from the first process to the second process. Alternatively, the second process can open the first process and duplicate the handle from the first process to the second process. Alternatively, the first process can use file descriptor passing techniques to pass the file descriptor or handle to the second process.

Communication

Interprocess, Intraprocess, and network communications are supported. Communication from a first process executing on a first computer to a second process executing on a second computer requires the use of a communication device. The operating system typically provides interfaces for communication connectivity and synchronization in using such communication devices. The operating system interfaces generally provide for a connect/send/receive/disconnect capability. Note, though, that a device can be referenced with equivalent functionality using an open/write/read/close interface, or some other interface as provided for by intermediary components of software providing equivalent functionality.

By way of example, but not limitation, the socket application programming interface can be used to facilitate communicate. On the Microsoft Windows operating system, equivalent Win32 Application Programming Interfaces can be used.

It is expressly understood that when a first process communicates with a second process, the communication may be sent by the first process on a first computer to a second process on a second computer and that such communication may be sent through intermediary computer systems on the network. Thus the communication from the first computer may be processed by one or more intermediaries before arriving at the final destination which is the second process.

It is expressly understood that when a first process communicates with a second process, the communication can be sent by the first process to a process executing on a second computer, and that this process can cause the communication to be made available to the second process. By way of example, but not limitation, the phrase “a first process sends a communication to a second process” can be understood as the first process sends a communication to a daemon process which receives the communication, causes the second process to begin executing, and causes the communication to be accessible to the second process. By way of example, but not limitation, the phrase “causes” can be interpreted as the process provides the second process with the file descriptor or handle, or, the process receives the communication and uses interprocess or intraprocess communications to make the communication available to the second process.

As provided for by U.S. Pat. No. 5,850,518 patent, a process can create a thread to perform the communication. By way of example, but not limitation, a first process can create a reader thread to receive a communication from a second process. When a message is received by the reader thread, the first process is notified and can access and interact with the message.

Various forms of encryption, message scrambling, or other such techniques can be used by the implementation to add additional layers of security as required by the implementation.

Content and Format

The term communicate implies content. It is further understood that the format of the content of the communication can be defined by the embodiment. By way of example, but not limitation, formats such as HTML, SGML, XML, schema information, data type information, name value pairs, text, or even components of software fabricated to convey the information. A shell script, for example, can have variable names and values to convey information. The only limitation is that the participants in the conversation must have a method to communicate the necessary information. This may, for example, include the use of various filters or translation services to transpose the communicated content from a first format to a second format, and possibly from the second format back to the first format. A multiplicity of formats may be used along the path as the communicated content moves along the network.

One skilled in the state of the art would understand that content could be expressed according to rules of grammar. For example, a scripting language such as KornShell, or Perl, or Tcl, or Tk, employ particular grammatical rules. It is understood that the content can be formatted according to a language's grammatical rules.

Furthermore, content can be filtered through various filtering techniques as defined by the implementation.

Furthermore, content can be verified through various verification techniques as defined by the implementation. By way of example, but not limitation, the verification can be implemented through one or more of:

the use of XML facets

the use of components of software such as that provided for by the Daytona Data Management system

the use of a binding service, such as that provided for by the methods of U.S. Pat No. 5,850,518

the use of industry standard protocols

the use of industry standard specifications.

Protocols

Communication implies the use of a protocol. A protocol defines a set of rules for communication. Protocols such as TCP, HTTP, FTP, computer mail protocols, application defined protocols, industry standard protocols, proprietary protocols, and the likes can be used. Once skilled in the state of the art would understand that various protocols could be developed in the future which can also be used for such communication. Furthermore, a multiplicity of protocols may be used as required. By way of example, but not limitation, protocols such as SOAP (Simple Object Access Protocol) can be used in conjunction with transport protocols such as HTTP. From the standpoint of the invention, all such protocols are contemplated for and collectively referred to as a protocol.

Consumer Service

The term consumer is meant as a consumer of a service. The service consumed can be an on-line service such as banking, electronic commerce, data acquisition, news reports, a service describing something of interest, changes to a web site, changes to a catalog, changes to what is available on-line, or even an online service such as that provided by an Internet Service Provider. Regardless, though, the service is provided by at least one component of software. A person, acting as a consumer, can also provide a service and such a service is referred to as a consumer service. In such cases, the consumer service is provided by a component of software.

A consumer causes a component of software to be installed on the computer system wherein the component of software provides a consumer service. Alternatively, the component of software can be pre-installed by a provider of such computing device as one may anticipate when purchasing a computer from a provider such as Compaq, Dell, or Gateway. Alternatively a component of software can be downloaded from the network which implies the use of transferring the component of software from a first computer to a second computer, the second computer representative of the computer system being used by the consumer.

Registry

The term registry is understood to imply a collection of related data. The term service directory could be used as well. The embodiment can use a database, a data management system such as the Daytona Data Management System from Global Technologies Ltd., Inc., a directory service, an ascii text file, a binary file, an indexed file, an industry standard method of organizing data, a method for administering data as provided for by an operating system, or other such techniques as would be understood in the state of the art, to facilitate the administration and administrative functions required. Such administrative functions can include one or more of collecting, organizing, accessing, interacting, verifying, replicating, or indexing of such information. A minimum administrative functionality set should include the ability to register, query, and delete. Additional administrative functionality would include the ability to change, update, or otherwise modify existing data. Within this specification, a directory service constitutes the application service for administering the data in the registry. When implemented with the Daytona Data Management System, a multiplicity of individual programs, libraries, applications can collectively constitute the directory service.

In a preferred embodiment, the Daytona Data Management System would be used instead of a commercial database system such as Oracle. The distinction is that Daytona provides full database capability in the development environment, and supports a runtime environment without the capability to define or add new tables and new schemas. A Daytona runtime environment has a significantly lower cost then comparable database systems such as Orcale or Informix, and does not require the customer to hire a database administrator. The Daytona system is specialized for run time applications needing data management, without the overhead of a Oracle or Informix.

Multiple registries can be used, and the registries may reside on different computers of the network. In one sense, this can be used to provide collections of services based on geographic areas. By way of example, a first registry contains entries representative of service providers providing service only within the state of New Jersey. A second registry contains entries representative of service providers providing service only within the state of New York. One skilled in the state of the art would understand that both registries could reside on a single server located in Connecticut, or on a first server in New Jersey and a second service in New York.

The organization of the data within the registry can be defined by a schema, as one skilled in the state of the art would understand the term schema. By way of example, a database consist of one or more tables, each table has a schema. An XML document may have a schema defining the content. A data management system provides the use of schemas for defining the content of a data set. The organization of the data within the registry can include a multiplicity of schemas. Thus a first data set having a first schema, and a second data set having a second schema, wherein the first data set and the second data set can be logically related to the task at hand.

An embodiment can use one or more in-core tables to facilitate the registry. Such techniques are known in the state of the art and are provided for with the Daytona Data Management System from Global Technologies Ltd., Inc. See the Daytona User's Guide for details.

The registry can include encrypted or compressed data and that this is implementation issue. When using the Daytona Data Management System, for example, a record class description can include compressed fields. From the services viewpoint, however, the data is uncompressed until saved by Daytona in a compressed format. Similarly, when the service requests data, the data may be decompressed by Daytona and provided to the service in an uncompressed format.

The registry can be implemented using horizontal and, or, vertical partitioning techniques. See the Daytona Users Guide for details.

Administrative functions can be implemented through access methods [access plans] as one would understand the term in database techniques. By way of example, but not limitation, a SQL statement can be used. The implementation, possibly through the use of an ODBC Compliant Driver, (or JDBC Compliant Driver) can create an access plan for accessing and interacting with the data. Similarly, a Daytona Cymbal statement can be compiled into object code and the object contains the access method.

Administrative functions can be implemented through a 4th generation language such as that of Cymbal, as provided by the Daytona Data Management System [see Daytona's User Guide].

An embodiment can use one or more components of software to facilitate administering the registry. In such content, the components of software can communicate as required by the embodiment. By way of example, a first component of software on a first computer can communicate with a second component of software executing on a second computer to facilitate an administrative function.

The schema can be implemented through the techniques of the Daytona Data Management System. The term Record Class Description equates to a schema. A component of software can include the access method for accessing and interacting with the registry.

The registry can be implemented as a Daytona Project and that one or more administrative functions can be implemented through a first Daytona Application, while additional administrative functions can be implemented through a second Daytona Application. A Daytona Application has one or more Record Class Definitions. See Daytona's User Guide].

A registry entry can consist of a multiplicity of information components, and an information component can have an attribute describing the use of the information component. By way of example, but not limitation, an attribute can be PUBLIC, in which case the information component is available to any requesting process. An attribute can be PRIVATE in which case the information component is only accessible to the entity requesting the registration in the registry. An attribute can be SECURE, in which case the information component is accessible to a process satisfying security criteria as defined by the implementation. In the use of attributes, a more robust implementation would define a service associated with the attribute such that the service can be invoked as necessary to perform the functionality desired. By way of example, but not limitation, the PRIVATE attribute can have an associated PRIVATE service that is called by the service accessing the registry, to perform the validation, parsing, filtering, or otherwise data manipulation required to fulfill the functionality of the service. One skilled in the state of the art would understand that such functionality and management of attributed field capability could be implemented with the Daytona Data Management System.

Program Listings 4.1 through 4.7 provide an embodiment of a directory service. The directory service is started by the generic front end loader, and listens on an Internet Address and port for requests. The directory service reads name/value information components, and acts upon them according to the specified command. The directory service configures the command table during initialization. In the current embodiment, the commands register, create, query, and delete are registered with the directory service. In a second embodiment, additional commands can be registered such as update, modify, replicate, report, and others. In a third embodiment, the commands to be registered can be read from a configuration file, such as that used by the software engine service. In yet another embodiment, the commands to be registered can be queried from a common directory service. The directory service accesses the request, and locates the command information component. The directory service then locates the corresponding registered command and accesses and interacts with the service associated with that command. By way of example, if the command is register, then the directory service locates the service associated with the register command and accesses and interacts with that service. In the embodiment of Program Listings 4.1 through 4.7, the directory service recognizes the “.private” attribute of an information component and treats such information components accordingly.

Note that an embodiment of the first directory service can access and interact with a second directory service to determine services to be provided by the first directory service. By way of example, the first directory service can communicate a request for services to the second directory service, and the second directory service can access and interact with the request to determine an appropriate response. The response may include one or more accessible services. This permits a first directory service to be configured according to the criteria supplied by the first directory service to the second directory service. In this regard, the first directory service may have a subset of services that the second directory service supports. By way of example, the first directory service may support a query command, but not a register command. Similarly, the first directory service may support an update command, but not a delete command. By way of example, the first directory service communicates a unique identifier associated with a service provider to the second directory service. The second directory service, responsive to receiving the identifier, accesses and interacts with the registry and determines the unique identifier has a particular security level associated with it. As a result, the second directory service communicates a response indicating one or more commands, and one or more services associated with each command, to the first directory service. Subsequent use of the first directory service would then be limited to those commands supported by the first directory service.

A multiplicity of registries can be maintained by the embodiment. Each registry can be accessed by a corresponding directory service. A multiplicity of directory services can be used. Each directory service can broadcast its availability. Such an implementation would use standard broadcasting techniques as defined in UNIX Network Programming series, Second Edition, W. Richard Stevens, Addison Wesley, ISBN 0-13-490012-X, or equivalent thereof. By way of example, a first directory service of a first computer of the network can broadcast its availability. A second directory service of a second computer of the network, responsive to receiving the broadcast from the first directory service, can register the first directory service with the second directory service. Alternatively, the first directory service could access and interact with the second directory service to cause the second directory service to register the first directory service.

The Unique Identifier

The term the unique identifier implies a sequence of characters used to uniquely qualify an entity. In this context, the term entity can represent a consumer, a service provider, a transaction, an entry in a registry, a thread, a process, a function, or a component of software. The reader will be guided by the context of the term to determine the corresponding entity referenced. For example, a consumer the unique identifier is understood as an identifier uniquely qualifying a consumer from other such consumers. A service provider the unique identifier is understood as an identifier uniquely qualifying the service provider from other such service providers.

The identifier can be a string of characters in the character code set understood by the embodiment. The identifier could contain white space.

An embodiment can use a multiplicity of strings to ensure uniqueness. For example, an identifier can include a first string and a second string as in:

IDENTIFIER: Northrup, C., 15 Spring Street, Suite 200, Princeton, N.J.

In this context, the uniqueness may require a multiplicity of information components such as Name, Address, City, State.

When used in conjunction with a Universal Description Discovery and Interchange Node (UDDI), a uddi_key can be used as the unique identifier.

When used in conjunction with a hashing service, the registration information, or a portion thereof, provided by the subscriber [ie., the consumer] can be communicated to the hashing service to generate a hash key.

The unique identifier can include a name value pair, or a multiplicity of name value pairs. This is especially useful when using a directory service to create an entry in the registry. By way of example, a unique identifier can include a first name and value indicating a specific data set (or registry) or logically related data sets. The second name and value pair can indicate a unique key within the data set. By way of example, a unique identifier “sd=payment_services id=cjn@gtlinc.com” would indicate that the service directory (ie. The registry) is called payment_services and id=cjn@gtlinc.com is within that registry.

A given person may have a multiplicity of the unique identifiers, each the unique identifier uniquely qualifying the person with respect to the activity the person is performing. A person at work may have one the unique identifier for work related activities, a separate identifier for home (or personal) related activities, and a separate identifier for organization activities (such as non-profit organization, little league, home-school association, political party activities). Note that a person may have the unique identifiers for other activities within an activity.

A user may interact with a component of software on the user computer to select the current the unique identifier as appropriate for the current activity. The interaction may be through means of a touch screen system, a pointing device such as a Microsoft mouse, speech recognition apparatus, and the like. Regardless of the implementation, software will be used in determining the current the unique identifier. The interaction may cause software to determine the activity and from the activity determine the unique identifier. The aforementioned may be determined solely by a process monitoring the activity of the user, by a process determining the activity of the user, or, by prerecorded information accessible to the process. Furthermore, such process may require interaction or communication with a second process as in the case of a first process communicating with a directory service.

When the computer system uses the named execution environment of U.S. Pat. No. 5,850,518, then a process can register attributes with the directory service. In such cases, a first user may have access to a first computer, which registers attributes describing a first process on the first computer. The implementation can use this information to deduce or otherwise determine the activity, or, the current the unique identifier, or a combination thereof. When the first user uses a second computer, then a process on the second computer can register attributes with the directory service. In such a case, the first user's activity or the unique identifier, or combination thereof, can be determined by the registered attributes of the second computer.

When the invention is used with the methods of U.S. Pat. No. 5,850,518, then a first process of the user's computer can communicate with a directory service to determine the current activity or the unique identifier, or combination thereof.

An implementation can use a unique identifier associated with a user, combined with access and interaction rights based on the network endpoint that the user is connecting from, to determine privilege and authorization. By way of example, a business maintains an enterprise wide network. An employee has an assigned the unique identifier. The employee uses a computer connected directly to the enterprise wide network (i.e., an ethernet behind a firewall). The employee provides their the unique identifier and can access and interact with a service within the enterprise (ie., behind the firewall). The employee leaves the office and goes home. From home, the employee uses an Internet Service Provider, such as America On-Line, to access the Internet. A process on the employee's home computer, connects to the enterprise service executing behind said firewall. The employee provides their the unique identifier. The enterprise service uses an authentication service and determines that the computer the employee is connecting from is outside of the enterprise wide network. The enterprise service then permits the process executing on the employee's computer to access and interact with a limited set of services. The limited set of services may be publically available services that are provided by the enterprise. For example, an administrator within the enterprise may configure the services such that access to customer information will only be granted to a requesting process executing within the enterprise, but, access to the company phone directory is permissible for requesting processes executing outside of the enterprise.

Dynamically Loadable Module

A dynamically loadable module is a component of software stored in a shared library, or a dynamic link library, or equivalent thereof, but collectively referred to as shared library throughout this specification. In a typical embodiment, a first function call is made to attach the shared library to the address space of the requesting process. A second function call is then made to access a particular module within the shared library. It is noted that certain embodiments can take advantage of an initialization function within the shared library that is automatically invoked when the shared library is attached or detached. Examples of this are the DllMain function, or equivalent thereof, as provided by the Microsoft Win32 Interface, and the init function as defined in the KornShell development kit. Various other implementations of shared libraries on UNIX support such initialization functions.

Function Call and System Call

For purposes of this disclosure, a function call and a system call are often collectively referred to as a function call. When a particular distinction is necessary, the term system call will be used.

It must be noted that the AST ToolKit, provided by AT&T Research, and described in Practical Reusable UNIX Software, John Wiley and Sons, ISBN 0-471-05807-6, includes numerous replacement functions via replacement libraries, related to file system access. The replacement functions currently offered by the n-Dimensional File System component of the AST Toolkit and the KornShell, do not augment these standard functions and system calls with access and interactions to services nor to directory service.

In various embodiments of this invention, a function of a process can be augmented by providing a replacement library containing a replacement function, and using dynamic loading techniques to dynamically load the replacement library (or component thereof), to facilitate the methods and systems of this invention. Alternatively, the corresponding application program could be linked with a library providing functions offering equivalent capability of the replacement function. When reading the term “replacement function” or “augmented function”, it is understood as a function providing an augmented capability or feature which is provided by a replacement function, or a function that the corresponding application program was linked with. Note that this may be in addition to the standard functionality of the corresponding function.

By way of example, the recv function is frequently used in network programming. (See UNIX Network Programming Volume 1 Second Edition, W. Richard Stevens, Addison Wesley, ISBN 0-13-490012-X.). An embodiment can augment the functionality of the recv function to access and interact with a directory service in order to facilitate administrative functionality such as replication, consistency, communication forwarding, and other services such as wire tapping, broadcasting and the like. Similarly, the functionality could include routing a received request to a second service. Thus, when the process makes the function call, the augmented version of the function can be used to augment or replace the standard functionality of the function.

By way of example, an augmented function can access and interact with a directory service to determine a service providing the underlying desired functionality. An embodiment could interact with a directory service to determine where the underlying functionality should be executed. A process issuing a write function, for example, could use the replacement write function which would access and interact with the directory service to determine how to access and interact with a write service providing means to write to an accessible device. Similarly, a process issuing a read function call, could use the replacement read function which would access and interact with the directory service to determine how to access and interact with a read service providing means to read from an accessible device. It is understood that such embodiments may require parameter passing from the process issuing the function call, to the service providing the underlying functionality. In such cases, the input types, and possibly the output types may also be communicated between the process and the service. An implementation could use SOAP/XML for such parameter passing, and possibly for one or more input types, as well as one or more output types. In this manner, a process compiled for a first operating system can be executed on the first operating system, but have one or more augmented function calls accessing and interacting with a service executing on a second computer of the network having a second operating system which may, or may not be different from the first operating system. Note that the service may be a process having means to perform the desired functionality and maintain state.

A first process can issue an open system call and have a file descriptor (or handle) associated with the opened file, but the file may physically reside on the second computer of the network.

By way of example, a code fragment written in the C language could include

int fd=open(“etc/profile”,O_RDONLY);

One skilled in the state of the art would understand that open is a system call and the functionality of the open system call is to open a file identified by the first parameter, which in this case is a file named/etc/profile, for read only. Upon success, the open system call returns a file descriptor value to the process and the file descriptor value is saved in the memory location given by the integer variable field. (For detailed information on the C programming language, see “The C Programming Language, Brian Kernighan and Dennis Ritchie, Prentice Hall Software Series, ISB 0-13-110362-8.)

When augmenting the open system call, the augmented open function can access and interact with a directory service and specify criteria for selecting a service. By way of example, the criteria could be a service having access to the /etc/profile file. If such a service is found, then the process can access and interact with the service to cause the service to perform the open system call. The service would have access to the file descriptor associated with the opened file. The service would remain executing, and would provide a response to the requesting process wherein the response indicates a value for the opened file descriptor. The response may be a value indicative of the maximum number of open file descriptors allowed by the operating system, plus the number of opened files that are opened by the service at the request of the process.

The process can then issue a read function call, and specify the value for the opened file descriptor. The augmented read function would examine the value of the opened file descriptor, and realize it is a value higher than maximum number of opened file descriptors supported by the underlying operating system. In this case, the replacement read function would deduct the maximum number of allowed opened file descriptors from the specified value for the opened file descriptor, and would access and interact with the service providing the underlying read functionality. In this sense, the replacement read function would provide the service with the appropriate file descriptor value, and possible other parameters, and the service would then perform the read system call, and provide the results thereof to the process.

The communication between the process and the service can be implemented using XML, or using other techniques such as messaging according to a format and possibly a protocol determined by the implementation. In one embodiment, the Safe-Fast-IO (sfio) interfaces are used (See Information Disclosure “Practical Reusable UNIX Software” for details on sfio).

The process may cause one or more standard functions to be executed on the same computer that the process is executing on. By way of example, certain environment settings and user administration may need to occur on the same computer as the first process, while other functions can be performed on a second computer according to this invention.

The process may also require a graphical user interface on the same computer that the process is executing on. In such cases, the functions calls related to the graphical user interface should not be processed by a service executing on a remote computer system.

The requesting process can register certain function calls that should be executed on the same computer as the requesting process. The augmented function would then determine if the underlying functionality is to be executed on the same computer, or should be executed by the service. To make such determination, the augmented function may access and interact with a directory service having the registered certain functional calls described above.

Certain functions return a pointer to a memory location. In such cases, an augmented function would access and interact with the service and the service would communicate the results thereof to the process. The communication can include representing data as characters, such as a hexadecimal character or equivalent (such as %32) and the data can be assembled into an allocated memory location accessible to the process. (See communication for details on communication).

The mapping of one or more return values and side effects of a function performed by a service can be determined by the implementation without changing the scope of the invention. Thus, a service executing a component of software on behalf of a process, can maintain state information about the results of the execution of the component of software, and, can communicate the results and side effects to the process, which are then assembled and made available to the process as if the function call were completed on the same computer and operating system of the process.

An embodiment can register additional information components about the devices, services, software, operating system, functionality, communication capability, characteristic and attributes thereof, and other information components as would be necessary to facilitate the invention. By way of example, this can include registration of the service having capability as disclosed herein. Such information may be necessary for the criteria as provided by the process.

When using name-value pairs, or other identifiers qualifying that portion of a request string which represent a service, the augmented function can use the directory service to discovery the corresponding component of software providing the service. For example, the open function call takes as a parameter, the name of the file to open. However, by providing criteria for accessing the file, the open function call can determine the service it should provide, by interacting with a directory service. By way of example, criteria specified as description=“Corporate information about GTL” can be provided to the open function call as the parameter. When the open function calls attempts to open a file with that name, the open will fail. Instead of returning an error condition, the open function call could interact with a directory service to see if there is a service that can satisfy the request. The directory service could either return back entry information and the open function could then access and interact with the service, or, the directory service can connect to the service satisfying the request. Thereafter, when a read function is called, the read function could receive information from the service and provide same to the process. Similarly, when a write function is called, the write function can send the data to the service. Finally, when the close function is called, the close function can disconnect from the service.

Operating systems typically are deployed with various supporting commands and utilities. By way of example, this often includes a shell, such as ksh. The shell interprets requests and performs desired actions. The POSIX standards define various shell commands and utilities which can be invoked by the shell.

On a Unix system, such as a Solaris 2.8 operating system, a frequent task is to invoke a cat command to display the content of a file. The cat command takes one or more command line arguments which are file names to display. The output of the cat command is displayed on standard output. Using the shell, one could cat the contents of a file and pipe the standard output as the standard input for a second command.

The cat command is invoked as a process and the process uses the open function call to open the file. By augmented the open function call with criteria, we can cat the contents provided as a service, as if the content where in a file on the local computer. Thus, the cat command itself does not need to be recompiled to take advantage of this capability. Instead, we use the augmented open function from a dynamically loadable library.

Similar behavior can be achieved for all standard UNIX commands and utilities that are dynamically linked.

Similar behavior can be achieved for all standard command and utilities of the U/WIN product line, as well as other applications that are dynamically linked. The U/WIN product line provides the KornShell and the shell commands and utilities for the Windows operating system.

Registration:

The registration can be an automated process such that whenever a service begins executing, it always registers its availability with the common directory service. Alternatively, the service can be accessible through a well-defined connection such as a URI, or on a dedicated Internet Address and port. In such cases, the registration process may occur once. In other implementations, a process having appropriate information about the service can register the service. In other implementations, the service may be registered via a user interacting with a graphic rendering program providing a form for the user to complete and submit electronically. Still, in other implementations, the registration process may be via computer mail. The registration process can also be implemented with SOAP/XML techniques. The registration process could also be implemented through remote procedure call, or equivalent thereof. Once skilled in the state of the art would understand that there are a multiplicity of methods for performing the registration process, even calling a person who could manually enter the registration information as required.

The registration process can include an identifier identifying the directory in which the registration is to occur. By way of example, a registration may indicate: sd=“Public Services” in which case the registration is to occur in the Public Services service directory. A default directory can be used when the registration process does not provide such a service directory identifier.

The registration information includes information provided by the process (or processes) participating in the registration. The registration information is said to contain one or more information components. An implementation can use a name-value pair for an information component, such as name=“Charles Northrup”, or, can use XML to communicate the information component, or various other techniques which may, or may not require a schema.

The implementation can support private and public attributes, as described in U.S. Pat. No. 5,850,518. In such cases, an information component can be marked as private, and thus would be accessible only to the directory service, but would not be returned in queries or reports. A private information component is always accessible to the administrator of the directory service. Similarly, a private information component is always accessible to the owner of the service.

An information component can be marked with a Group attribute. According, members of the specified group (or processes acting on their behalf) would have access to the information component.

Implementations can use underlying operating system security semantics as well. For example, a Unix system supports the notion of read/write/execute permissions for owner, group, and others. Such operating system semantics can be used.

The registration process can include the use of a graphical interface to make the registration experience more pleasurable for the user. Such implementations could be facilitated through the use of the Microsoft Internet Explorer or equivalent thereof. Alternatively, the graphical interface can be provided by other means, as one skilled in the state of the art would understand.

Note that some implementations will have the directory service provide required registration information to the registering process, and that such information may be communicated to a user of a computer system, and that the user would provide the required information and the required information would then be accessible to the directory service.

The registration information is administered by the directory service, which can use a registry to provide persistence for the data.

A service provider can register a multiplicity of registrations with the common directory service. This can permit artificial intelligence methods for the selection of the service satisfying criteria. The selection can include events, time specifications, access methods, communication methods, methods providing selection based on response times, and the like. In such cases, a service provider can register that the service provided by the service provider at a particular network endpoint is accessible only during certain hours of operations, which may include day of week, month, year, etc. The same service can be registered for a different network endpoint for a different hour of operations, which may include day of week, month, year, etc. The only restriction is that duplicate entries in a single service directory are not supported.

It is noted that replication of entries between service directories registries may be provided by the implementation. In such cases, a first directory service can provide a second directory service with one or more registration entries maintained by the first directory service, in order to replicate the data maintained in ithe registry. An implementation can use the methods of U.S. Pat. No. 5,572,709, or equivalent thereof. Each time an entry is written to the registry, the write(2) system call can be augmented to duplicate the write request to a remote file store. The write(2) system call can also use the directory service to determine a remote process having capability to receive registry updates. The write(2) system call can connect to the remote process and communicate the information related to the write system call. The remote process would receive the communication and perform equivalent action to a data store maintained by the remote process. The remote process can either update its registry immediately, or, store the communication until sufficient communications have been received, and use bulk data loading techniques to bulk load the data.

In a second implementation, a first directory service receives requests, and depending on the request received, will duplicate the request to a second directory service. By way of example, the first directory service receives a request. The request is scanned to determine if the request is to register a new service, and if so, the first directory service accesses and interacts with a remote directory service to replicate the request. This would be in addition to the first directory service performing the operations of the received request.

To maintain consistency, other request such as delete, modify, change, update, and others can also be replicated.

The implementation can provide this capability in a function of a dynamically-linkable replacement library. One example of a dynamically-linkable replacement library is found in U.S. Pat. No. 5,572,709.

By way of example, a gethostbyname standard operating system interface call can be augmented to access and interact with a directory service as required. (See UNIX Network Programming Networking APIs, UNIX Network Programming series, Second Edition, by W. Richard Stevens, pp 240-246, ISBN 0-13-490012-X for details on the standard gethostbyname operating system interface.) Program Listing 1.1 provides a source code listing of one implementation for the replacement gethostbyname function which is then compiled into object code, and archived in a replacement shared library with the same filename as the standard shared library containing the operating system provided gethostbyname function. Using the LD_LIBRARY_PATH environment variable setting to first point to the location of the replacement shared library; the replacement gethostbyname function would be used whenever a process invokes the gethostbyname function.

The standard system version of the gethostbyname function accepts a single parameter hostname, which is a pointer to a character string and returns a pointer to a hostent structure on success, or a NULL pointer on failure (Program Listing 1.1 line 3).

In this embodiment, the gethostbyname function will first invoke the system version of the gethostbyname function (Program Listing 1.1 line 8) to see if it is able to resolve the host name reference given by the value pointed to by parameter hostname.

If the system version of the gethostbyname function is not able to resolve the hostname, then the gethostbyname function will consider the host name reference given by the value pointed to by parameter hostname as criteria for selecting a service. In this case the gethostbyname function will query the directory service (Program Listing 1.1 line 12) and will examine the results of that function to see if connectivity has been registered for a service satisfying the criteria (Program Listing 1.1 lines 13-18). In this case, the gethostbyname function will then invoke the system version of the gethostbyname function (Program Listing 1.1 line 19).

In a second embodiment, the standard operating system interface call can include the necessary computer instructions to access and interact with the directory service.

Other embodiments are possible. By way of example, the gethostbyaddr, gethostbyname2, getservbyname, getservbyport, getnameinfo, and others, can have appropriate replacement functions to access and interact with the directory service. This is not limited to socket application programming interfaces. By way of example, an open system call can be modified to access and interact with a service, through the use of a directory service.

The benefit of using replacement dynamically loadable libraries is that the original source code for the application program need not be modified to gain the advantage of working with the directory service. Thus, applications, such as telnet, Netscape communicator, ftp, ping, and others, can immediately take advantage of the directory service, without having to recompile the application.

By using a replacement dynamic link library with an alternative gethostbyname function, the user can enter information that can then be communicated to a directory service, and the appropriate response displayed.

In an enterprise network, such as within the Global Technologies Ltd., Inc., domain (gtlinc.com), we can maintain a registry containing contact information for our employees. When using the browser, a first employee can enter “contact information for Charles Northrup” and the directory service locates a service providing that information, accesses and interacts with the service, and communicates the response from the service, to the browser process.

Netscape 4.73 and Microsoft Internet Explorer version 5.0 permit the user to enter a string. Both products attempt to resolve the entry by using a domain name lookup service, usually provided by gethostbyname (or equivalent thereof). When a domain name cannot be determined, both products will interact with web search engines to determine a relevant page. By way of example, the Microsoft Internet Explorer will communicate with the Microsoft Service Network search engine site. If the string was entered as C:\, then both products insert a file schema and as translate the request as file:///C|/. Neither product permits access and interaction with a directory service.

The implementation can also be provided directly by the operating system interfaces themselves.

An example directory service is shown in Program Listings 4.1 through 4.7. The embodiment provides for a register command, a create command, a query command, and a delete command. When registration is to occur, the name/value pair may include a “.private” notation to indicate that the name/value pair is private, and should not be reported as part of a query command. As an example:

Name=“charles northrup” phone.private=609-924-7305

In this context, the registration entry will include two information components. The first is a name component, having value “charles northrup” and the second is a phone component having value 609-924-7305. When querying the directory service using:

Command=query name=“charles northrup”

then the query will report the name component and its value, but not report the phone component nor its value.

An implementation can add a “.mandatory” attribute to an information component to force the specified information component to be included in a query request. By way of example,

Command=register name=“charles northrup” phone.mandatory=609-924-7305

In this example, a query request must include phone=609-924-7305 in order for the entry to be included in the query results.

An implementation can add a “.group” attribute to an information component such that the a group list is maintained by the directory service, and only those belonging to the group can see the results of the query. By way of example:

Command=register name=“charles northrup” group.mandatory=officer

In this example, a query request with criteria name=“charles northrup” would require the request process to supply additional information so that the directory service can determine if the request is on behalf of a member of the specified group.

Note that the use of the attributes can be extended to a connect request facilitated by the directory service. In such cases, a request of:

Command=connect name=“charles northrup”

Would be subject to the same constraints as the query command, as described above.

In assigning attributes to information components within a registry entry, an implementation can use the directory service itself to access and interact with a service providing the desired functionality. By way of example, the private attribute described above can be a registered service within the common directory service (CDS). When the CDS receives a query command, and locates one or more entries satisfying the request, the CDS could access and interact with a “private” service which could perform translation to an empty string for that information component. In a another implementation, an information component can have a “normalize_to_upper” attribute and the CDS would access and interact with the service providing normalize_to_upper normalization of the data content for the value portion of the name/value information component.

Registration Information

By way of example, but not limitation, this may include one or more of:

consumer information

name

street address

city

state

country

postal code

information representative of the consumer computer

information representative of the operating system of the consumer computer

information representative of the communication devices of the consumer computer

information representative of components of software accessible to the consumer computer

consumer contact information such:

telephone number

fax number

beeper number

pager number

wireless access number

cellular phone number

company information

affiliation information

corporation information

non-profit business information

organization information

agency information

consumer add-on services

consumer subscribed services

consumer billing information

consumer payment information

consumer historical usage information

consumer historical payment information

consumer transaction information

consumer security information

consumer profile information

consumer access information

consumer geographical information

consumer preference information

consumer enhancement service information

payment type

payment provider unique id

payment account unique id

payment billing information

payment billing name

payment authorization unique id

payment provider id assigned expiration date

payment provider code

payment bank unique id

payment bank authorization unique

connectivity required to reach a service

access point

Internet address

port

protocol

network type

data representation

service availability time

duration of service

owner information

group information

When used in conjunction with the methods of U.S. Pat No. 5,850,518, the information can include one or more of the information components as defined in the thread directory service. By way of example, but not limitation, this can include the physical connectivity required to reach the consumer, the consumer service, or any service including a minor service, a communication primitive to be used in communications wherein the information on the physical connectivity required is used by the communication primitive to establish connectivity. As an example, a consumer computing device connects to the Internet through an Internet Service Provider [ISP] and is assigned a dynamic Internet Address. The registration information can include the dynamic Internet address and possibly one a port for sending and receiving communications. One skilled in the state of the art would understand that a multiplicity of ports may be used in facilitating the communication.

Alternatively, if the consumer computing device has a static Internet Address associated with it, that the static Internet Address and a designated port can be registered. One skilled in the state of the art would understand that a network address and possibly a port number, or equivalent thereof, can be used. By way of example, an Internet Address may be 192.127.0.3 and a port may be 3999. Alternatively, an Internet Address can be workhorse.gtlinc.com and a binding service such as that provided by the name daemon or equivalent thereof would bind workhorse.gtlinc.com to an appropriate network address.

Accesses and Interacts

The phrase accesses and interacts implies the use of a multiplicity of processes. The processes may communicate via interprocess communications, intraprocess communication, or through a communication device as supported by the underlying operating system. Communications can be instrumented through protocols. A first process can be executing on a first computer of the network, and a second process executing on a second computer of the network. It is understood that this may include one or more intermediary processes to facilitate the communication, as determined by the protocol. It is understood this may include one or more intermediary processes to facilitate the communication, as determined by the network. The network can be the Internet, a private network, a public network, or some other network such as the virtual network as described in U.S. Pat. No. 5,850,518.

The phrase access(es) and interacts can also imply loading a dynamically loadable module into the address space of the first process and invoking a function entry point in the dynamically loadable module either directory, or indirectly through an initialization function supported by the underlying implementation. By way of example, the DllMain function is invoked whenever a dynamically linked library is attached to a process.

Criteria

Criteria can be implemented through name/value pairs, which may include using regular expressions and possibly even using Boolean operators, through SQL statements, through OBDC instructions, JDBC instructions, Microsoft ADO.NET, through Daytona Cymbal statements, and other implementations. The interpretation of the specification of the criteria is implementation dependent. Various protocols can also be used. A natural language system could be used in conjunction with the directory service, to interpret the criteria. Examples of Natural Language Systems include CHAT, from Network Services and Interfaces Laboratory, Communications Research Centre, 3701 Carling Ave. Ottawa, ON CANADA K2H 8S2. Additional technical papers include A Form-Based Natural Language Front-End to a CIM Database, Nabil R. Adam, Aryya Gangopadhyay, March-April 1997 (Vol. 9, No. 2), Knowledge and Data Engineering, IEEE (also available at http://www.computer.org/tkde/tk1997/k0238abs.htm).

Preprocess

The term preprocess, as used in this specification, indicates a service that is to be performed on a communication prior to primary processing. By way of example, this may result in a second memory location being made available to the process wherein the second memory location has the results of the preprocessing. By way of example, the preprocess service may:

translate a communication

interact with a service to alter the communication such as macro expansion, or regular expression evaluation

decrypt the communication

unscramble the communication

access and interact with a directory service to ascertain information elevant to the communication

convert a component of the communication from a first format to a second format, such as converting a string to a hexadecimal number, an integer, a binary value, . . . etc

convert a component of the communication from a first arbitrary named representation to a second arbitrary named representation

normalize a component of the communication, such as in changing the case, the format, or the data representation.

The preprocess service may be dynamically loadable. The implementation may determine which preprocess service to dynamically load. Such determination could be made by accessing and interacting with a directory service, and possibly by using a component of the communication.

By way of example, a first process receives a communication and examines the communication for a name/value pair. The first process uses the name/value pair as criteria for selecting a preprocess service. The first process accesses and interacts with the preprocess service.

A communication received by the first process can be encrypted according to a first encryption method. The first process would then access and interact with a service providing decryption of the communication according to the first encryption method. The same first process can receive a second communication encrypted according to a second encryption method. The first process would then access and interact with a service providing decryption of the communication according to the second encryption method. By selectively accessing and interacting with the preprocess service, additional encryption/decryption methods can be devised in the future and the first process will be able to take advantage of same without having to recompile the first process.

A communication received by the first process can be formatted according to a first protocol. The first process can access and interact with a service providing translation of the communication from the first protocol to a second protocol. The first process would then process the communication according to the second protocol.

A communication received by the first process can be formatted according to a first language. The first process can access and interact with a service providing translation of the communication from the first language to a second language. The first process would then process the communication according to the second language definition.

A communication received by the first process includes a mixture of upper case and lower case characters. The first process can access and interact with a normalization service providing means to convert one or more of the lower case characters to upper case, or upper case to lower case as determined by the implementation. By way of example, the URL http://www.gtlinc.com/research/research.html, can have a portion of the URL normalized, while the remainder of the URL remains as received. One implementation can convert http://www.gtlinc.com, from lower case to upper case, while a second implementation may convert from upper case to lower case. When the communication includes a component which is relative to a well known root, then the normalization may convert the relative portion to a fully expanded name which includes the root. By way of example, a relative URL given as research/research.html, may be normalized to the fully qualified name of http://www.gtlinc.com/research/research.html.

Note that it is possible for a NULL preprocess service to be indicated to the first process, in which case, the first process would not call the preprocess function.

Note that a preprocess service may allocate and initialize even in part, a memory location to be used by the first process.

Postprocess

A first process may access and interact with a post processing service. In the case of a software engine, the postprocess service performs deallocation and garbage collection of memory allocated, frequently by the preprocess service. Postprocessing can also include translation, formatting, normalization, and even encryption of a response, prior to sending the response.

Common Directory Service

The phrase common directory service implies a directory service accessible to a requesting process (or a service), and, containing information related to a desired service. A component of software can be used on a first computer of the network to communicate with the directory service executing on a second computer of the network. An implementation can use a multiplicity of directory services, and, that a directory service may access and interact with additional directory services, as necessary. A process may also be configured to have direct access to the directory service as a function of the process. In such cases, the process invokes a function providing the administrative feature desired (i.e., registration, query, unregister, modify, update, create, join, select, . . . etc).

Facilitates the Connection On Behalf of the Requesting Process

The phrase facilitates the connection on behalf of the requesting process implies the directory service connects the requesting process to the desired service. One skilled in the state of the art would understand that an implementation of the directory service could provide the required connectivity to reach the service, to the requesting process, and the requesting process could connect to the service. One skilled in the state of the art would also understand that an implementation of the directory service could include the Thread Communication Service as disclosed in U.S. Pat. No. 5,850,518. One skilled in the state of the art would also understand that there are variations of the implementation within the scope of the invention that can be used to facilitate the connection.

### DETAILED DESCRIPTION

A service is executing on a computer system on a network. The service can be listening on a network endpoint, such as an Internet address and port. The implementation can use the socket application programming interface, or some other method as provided by the underlying operating system interfaces for communication connectivity and synchronization. For the service to be used by a requesting process, the service must first be registered (see registration) with a common directory service.

The requesting process begins execution, and accesses and interacts with a common directory service. The requesting process specifies criteria for a desired service.

The common directory service locates a service entry satisfying the criteria, and facilitates the connection on behalf of the requesting process to the desired service.

A user of the computer may be interacting with the requesting process. The user can cause the computer operating system to access and interact with a process to complete registration.

The user can communicate a request for a service to a requesting process. In this context, the user is referred to as a consumer. The requesting process would then access and interact with the common directory service on behalf of the user. The requesting process, which may first need to preprocess the user request, can provide the request to the directory service.

The requesting process can then access and interact with the desired service.

Since the user is a registered user, the service can access and interact with the common directory to determine public registration information components about the user.

Similarly, the requesting process can access and interact with the common directory service to determine public registration information about the service. In certain implementations, the requesting process can access and interact with the common directory service to determine public registration information about the provider of the service. The requesting process may communicate such determined information to the user, either through audio or graphically through the use of a graphical user interface, or text based as one might use the curses library available on UNIX derived implementations. The requesting process may access and interact with a component of software accessible to the requesting process to filter out certain services deemed inappropriate or undesirable.

A registered consumer can also provide a service. To provide the service, the consumer must register the service with the common directory service. Once registration is complete, the service provided by the consumer will be accessible through the common directory service.

A service provided by the consumer can be implemented with a callback capability. By way of example, a consumer request a service from a service provider, and the consumer must pay for the service. In this context, the consumer supplies service provider with access to the consumer's the unique identifier. The service provider service accesses and interacts with the common directory service to request access to the consumer's payment information service. The common directory service locates the consumer service satisfying the request, and creates a transaction identifier to indicate that a transaction is in progress. The common directory service can complete a registration of the pending transaction. The common directory service then accesses and interacts with the consumer payment service. It provides the pending transaction unique identifier to the consumer payment service, and then disconnects. The consumer payment service then accesses and interacts with the common service directory specifying criteria including the unique identifier of the pending transaction registration entry. In this context, the consumer payment service is now a requesting process. The common directory service then facilitates the connection on behalf of the requesting process to the service provider process awaiting payment information, as identified by corresponding transaction id.

When using the invention on a computer system behind a firewall, a consumer providing a service may request a service provider providing a service hosting service, to host the consumer service on behalf of the consumer.

When using the invention on a computer system behind a firewall, the service can complete registration with the common directory service indicating that request to access the service from the common directory service are to be facilitated through a protocol, such as computer mail protocol. Thus, the common directory service would send computer mail to the owner of the service, and a service process executing on the computer system would read the computer mail and determine that there is a request for the service. The service process would then facilitate a connection to the central directory service. In one embodiment, the service process can provide the request to the requested service and the requested service would then access and interact with the common directory service. In a second embodiment, the service process would access and interact with the common directory service on behalf of the requested service. It is noted that an implementation can use various methods for automating the registration process in this regard, and defaulting to computer mail protocol when other types of connectivity cannot be established.

When accessing and interacting with a service, a requesting process can communicate according to a first protocol, which is then brokered by the common directory service to a second protocol as required by the service. Alternatively, a service process can communicate according to a first protocol, which is then brokered by the common directory service to a second protocol as required by the requesting process. In such cases, this may include the use of language translations. By way of example, a first language can be formatted according to the rules of a second language. The broker service can use a translation service to perform such translations according to well-defined rules. The translation service may also use templates as required.

Various embodiments of using services, communication flow between services, registration of services, ordering of registration, ordering of callbacks, are presented. Once skilled in the state of the art would understand that various permutations are permitted by the invention. Thus, a callback in one service could easily be implemented in a second service, as appropriate.

Additional Services

Numerous additional services can be added to the consumer service, the provider service, or the central service. Such additional services are contemplative of means to facilitate the transaction, and to ease the burden of administering the data associated with the transaction. Examples of such services are:

a component of software accessible to the consumer computer which activates upon notification of pending transaction, to alert the consumer that a transaction is now in progress. The alert may be audio or visual, or combination thereof. By way of example, the component of software may cause an icon to become visible while the transaction is in progress.

a component of software accessible to the consumer computer that activates upon notification of pending transaction and requires the consumer to select an “Authorize Payment Information Transfer” option. If the consumer does not select the option within a predefined period of time, then the transaction would abort. Alternatively, a “Decline Payment Information Transfer” option may be selected by the consumer, and the transaction would abort. By way of example, the component of software may display such options as graphical representations for the user to select via depressing a mouse button (i.e., “click”).

a component of software accessible to the consumer computer to permit the consumer to select a current payment option from a plurality of payments options available to the consumer. By way of example, a consumer has a multiplicity of credit cards and maintains payment information for each such credit card. When notified of a pending transaction, the consumer can select which of the registered credit cards is to be used.

a component of software accessible to the consumer computer to permit the consumer to select a current payment option from a plurality of payment options communicated by the service provider to the central service, and from the central service to the consumer service. By way of example, a service provider may accept only American Express credit cards. By communicating this to the central service, and from the central service to the consumer service, then the consumer service can alert the consumer that American Express is the only credit card accepted by the service provider. Accordingly, the consumer service can automatically select the American Express registered information and communicate such information back to the central service [and from the central service to the service provider].

a component of software accessible to the consumer computer to temporarily deactivate, or to terminate, the consumer service providing the payment information. By way of example, the consumer can use a mouse connected to the computing device to select an icon, such as a wallet, or a purse, to indicate that it is to be closed. In closing the wallet, the consumer service providing the payment information would then be deactivated or terminated. Similarly, selecting the same icon [or a different icon which graphically conveys the notion that the wallet is closed], can cause the consumer service to reactive. In such instances one can use a first icon to indicate the consumer service is not executing, and a second icon to indicate the consumer service is executing.

a component of software accessible to the consumer, providing means to communicate with the central service. This provides means interact with the central service to facilitate transaction reports, to inquiry on service providers having registry entries containing the consumer the unique identifier, to change keywords recorded in the registry for the consumer for a specified service provider, or, for facilitating administrative functionality as one would anticipate for a consumer/service provider relationship.

a component of software accessible to the central service to alert consumer of transaction in progress. This may include changing an icon from a first color to a second color to indicate the transaction in progress, and back to the first color once the transaction is complete. Alternatively, the component of software can display one of two different icons to indicate the current state as either in progress, or, transaction complete.

a component of software accessible to the central service to periodically verify the consumer through interaction with the consumer service.

a component of software accessible to the central used by the central to track frequency of use based on statistical analysis to alert for possible fraud.

the service provider can communicate payment options to the central. The central can send the information to the consumer service. The consumer service can alert the consumer to the available payment options, and the consumer can select a particular option for that transaction.

the service provider can communicate total payment required to the central. The central can send the information to the consumer service. The consumer service can alert the user and possibly request authorization based on the total amount of the payment.

the service provider can communicate transaction details to the central, which then communicates the information to the consumer service, providing the means for the consumer service to detail the information on the consumer computer.

a component of software accessible to the service provider process which communicates with the central service, to provide certain consumer registry information to the service provider. In this context, a field marked as PUBLIC, can be returned to the service provider. Thus, a consumer can supply the service provider with the consumer's the unique identifier, and the service provider can contact the central service, communicate the consumer's the unique identifier, and receive a communication from the central service representative of the consumer's registered information that is publicly available through the registry implementation.

Software Engine Service

A service can be instrumented through a software engine. The software engine uses a specification describing one or more components of the engine. The specification is referred to as the engine configuration specification. The components of the engine are referred to as the component services. Note that a component service provides a service, and hence the component service is often referred to, more simply, as service. An example of an engine configuration is provided in Program Listing 2.16.

A minimal engine specification contains sufficient information for the software engine to associate the component identified in the specification with a service, which may be provided by a component of software. As such, the engine can access and interact with the service as necessary to perform the desired action.

As an example, a specification can identify a given service that is to be dynamically loaded through the use of one or more operating system interfaces.

It is expressly understood that the specification of the engine components can be facilitated through a schema. In use with the Daytona Data Management System, a record class provides equivalence of a schema.

Similarly, a specification can be facilitated through the use of one or more data structures.

Similarly, a specification can be facilitated through the use of one or more name spaces. A name space may be facilitated by the operating system, an application having means to interpret a name space, a middleware layer having means to interpret the name space, an interpretive language processor having means to interpret the name space, or through the use of a directory service such as LDAP, Microsoft Active Directory, or the Thread Directory Service of U.S. Pat. No. 5,850,518. By way of example, but not limitation, a name space could be given as:

| | engine= |
|---|---|
| | ( |
| | component=authenticate |
| | ( |
| | name=auth; |
| | location=libservices.so.1.0; |
| | ) |
| | component=input |
| | ( |
| | name=readline; |
| | location=libservices.so.1.0; |
| | physical=127.0.0.1:9998 |
| | ) |
| | ) |
| | A similar specification could have been given as: |
| | engine=test_engine |
| - | engine.authenticate.name=auth; |
| - | engine.authenticate.location=libservices.so.1.0; |
| - | engine.input.name=readline |
| - | engine.input.primitive=inet |
| - | engine.input.physical=127.0.0.1:9998 |

Various methods for providing the specification could be implemented through various name space techniques. Such techniques could include the use of SOAP/XML, XML, or other protocol and, or language specifications.

By way of example, but not limitation, the engine could be designed to:

communicate with a service to discover the specification, or

communicate with a service that sends the specification to the engine, or

access and interact with an accessible file to determine the specification, or

access and interact with environment settings to determine the specification, or

access and interact with operating system interfaces to determine the specification., or

access and interact with a service to discover the specification, or

use one or more of the above to determine the specification.

When an engine must determine the data type of a specification component, the engine could access and interact with a service providing such information. By way of example, but not limitation, ODBC, JDBC, backtalk, XML schemas, and other such methods can be used. One skilled in the state of the art should interpret this to imply that the engine can interact with a service providing the detailed information on one or more components of the specification in order to determine the data type.

Alternatively, the engine can use a binding service such as that provided for in U.S. Pat. No. 5,850.518 to determine the association of an identifier with an entity understood by the binding service. By way of example, but not limitation, the binding service can use a method providing means to associate the identifier to a data type. The engine can then request information from the binding service to receive the data type information. In such cases, the binding service method can use a service such as ODBC, JDBC, backtalk, XML schemas, or other such methods as appropriate.

An engine can be implemented with a services of components preconfigured, but dynamically loaded as specified by the specification. By way of example, a standard engine could provide:

authenticate—a service for determining if the requesting process is authorized to use the service

input—a service providing means to receive input

preprocess—a service providing preprocessing of the input

process—a service providing primary processing

postprocess—a service providing postprocessing of a response

response—a service providing a response

The standard engine can also access and interact with one or more of: a startup service, a shutdown, and an engine configuration service.

A specification for the standard engine may include:

Component=authenticate name=auth location=libauthenticate.so.1.0

This would instruct the engine to dynamically load the authenticate service given in the dynamically loadable library called libauthenticate.so.1.0, and module name auth.

When configured with a directory service, the above specification could be given as:

Component=authenticate name=auth

This would instruct the engine to use a directory service to locate the service named auth, and to access and interact with the service accordingly.

A specification for a standard engine may include a placeholder service for a component. In this case, the engine will access and interact with the placeholder service even though the placeholder service contains a simple return statement or exit statement and performs no other action.

An authentication service can be implemented to determine if the process accessing and interacting with the service, is permitted access to the full capability of the engine. For example, an authentication configuration file can store information indicating a host, and indicating if the service is allowed or denied according to the host. The authentication service can then access and interact with the authentication configuration file to determine is full access is granted.

Authentication can include receiving a unique identifier assigned to an entity providing a service (or a registered user), and determining if the entity is permitted according to the rules of the authentication service. By way of example, an authentication configuration file can include:

CID=0x1924865319279337 host=gtlinc.com command=allow

CID=0x1924865319279337 host=* command=deny

When the authentication service is invoked, the host computer requesting the service must be gtlinc.com and the request must include the CID value 0x1924865319279337.

The authentication service configuration specification can require the authentication service to access and interact with a directory service that a specified component appears in a registry entry. By way of example, a configuration specification of:

criteria=“host=gtlinc.com cid=?” command=allow

would cause the authentication service to fill in the cid value according to the received communication, and provide that name value pair, as well as host=gtlinc.com name/value pair, as criteria for the directory service to determine if the specified cid entry contains host=gtlinc.com. If so, the engine would continue processing, otherwise, the engine would deny access. Note that in this example configuration specification, the value of cid=? would be interpreted by the service as a macro expansion to be completed by the service. In this case, the service can use a component of the communication, or equivalent thereof, to complete the value portion of the name/value pair.

It is understood that when the authentication service must receive a communication containing an information component, then the authentication service may access and interact with an input service and possibly a preprocess service, before authentication can be completed. This may be necessary when the authentication service requires the requesting process to provide name/value pairs.

Note that unlike the UNIX inetd process, which can use a TCP Wrappers implementation to determine if the request from a remote system is authenticated, the use of the engine is on a per engine basis. Each authentication service can have its own authentication configuration specification, regardless of the network endpoint on which the requesting process is listening on. Similarly, each authentication service can have its own authentication configuration required for a two-way handshake when a requesting process connects to a service. That is to say, the requesting process can use the authentication service to verify the connected service, just as easily as the connected service using an authentication service to verify the requesting process has access rights to the service.

In the embodiment provided in Program Listing 2.0 through 2.18, the software engine is configured to access and interact with a startup service, if defined in the engine configuration. Similarly, if the engine configuration specifies a shutdown service, then the engine uses the atexit operating system interface to cause the shutdown service to be invoked when the engine terminates. The basic engine components are given as authorize, input, preprocess, process, postprocess, and response. Placeholder services are used for each of the aforementioned services. During initialization, the engine accesses and interacts with the configuration to determine what service components are specified, and how to access and interact with them.

The startup service is typically used for memory allocation of one or more data structures used by the components. In general terms, the startup service performs resource initialization. By way of example, the startup service may access and interact with the common directory service to determine available services, entities providing services, characteristics of entities or services, registration, and similar operations.

The shutdown service is typically used for memory deallocation and performing closure routines. The shutdown service, in general terms, deallocates resources. By way of example, the shutdown service may access and interact with the common directory service to deallocate resources, deregister, or perform other operations. On a Windows operating system, the embodiment may use the atexit function, or equivalent thereof.

Program Listing 2.17 shows a second embodiment of the software engine. In this embodiment, each time the engine is called, the engine will call the configure_engine service (function) to perform engine configuration. In this sense, each time the engine is to do something, it will always reread the configuration specification to determine the current engine components. This permits a first set of engine components to be provided in a first engine configuration specification, and a second set of engine components to be used for subsequent engine processing.

When used with the generic front end loading service (gfel), we can specify that the engine provides a service by invoking gfel with the appropriate parameters. By way of example:

gfel name=engine location=libengine.so.1.0 primitive=INET physical=192.168.200.15:999

causes gfel to start the engine listening at internet address 192.168.200.15 port 999. When used with gfel, the engine can include an administrative service such that when accessing and interacting the administrative service, the engine component parts can be reordered, replaced, or otherwise permitting dynamic reconfiguration of the engine.

Program Listing 2.18 shows a third embodiment of the software engine. In this embodiment, the number of engine components parts, nor their ordering, are predetermined by the engine. Instead, the components are determined by reading an engine component specification. Component ordering is maintained based on fifo ordering. In an alternative embodiment, a hash list, or other mechanisms known in the state of the art can be used. By way of example, component ordering can be determined by specifying the component order number in the configuration specification, or, by deducing component order specification based on dependency, or, establishing component ordering based on rules. The engine can determine the components and their ordering by processing the engine configuration specification. In an alternative embodiment, the engine could access and interact with a service to determine the engine component specification. For example, the engine could access and interact with a common directory service to query for information components containing a keyword such as keyword=engine.conf, and use the results of the query to configure the engine.

Authentication Service

An authentication service provides authentication for use of a service. A widely used and well known authentication mechanism is tcpwrappers.

The following paragraphs are from The Red Hat Linux 7.2: The Official Red Hat Linux Reference Guide:

TCP wrappers and xinetd control access to services by hostname and IP addresses. In addition, these tools also include logging and utilization management capabilities that are easy to configure.

Many modern network services, such as SSH, Telnet, and FTP, make use of TCP wrappers, a program that is designed to stand between an incoming request and the requested service.

The idea behind TCP wrappers is that, rather than allowing an incoming client connection to communicate directly with a network service daemon running as a separate process on a server system, the target of the request is “wrapped” by another program, allowing a greater degree of access control and logging of who is attempting to use the service.

The functionality behind TCP wrappers is provided by libwrap.a, a library that network services, such as xinetd, sshd, and portmap, are compiled against. Additional network services, even networking programs you may write, can be compiled again libwrap.a to provide this functionality. Red Hat Linux bundles the necessary TCP wrapper programs and library in the tcp_wrappers-<version>RPM file.

When someone attempts to access a network service using TCP wrappers, a small wrapper program reports the name of the service requested and the client's host information. The wrapper program does not directly send any information back to the

client, and after the access control directives are satisfied, the wrapper gets out of the way, not placing any additional overhead on the communication between the client and server.

TCP wrappers provide two basic advantages over other network service control techniques:

The connecting client is unaware that TCP wrappers are in use. Legitimate users will not notice anything different, and attackers never receive any additional information about why their attempted connections failed.

TCP wrappers operate in a manner that is separate from the applications the wrapper program protects. This allows many applications to share a common set of configuration files for simpler management.

Thus, an application program must be linked with the libwrap.a library. Once deployed to the field (i.e. a customer site), then the application program is static with well defined functionality. Thus, a replacement tcpwrapper cannot be used, unless the application program is recompiled (i.e., linked against libwrap.a) and redeployed.

Another disadvantage is that tcpwrappers can be used to authenticate a request for a particular application program from a client at given Internet Address, but does not authenticate individual services provided by the application program. A given application process can use tcpwrappers to authenticate based for the primary service provided by the application process, but, does not use tcpwrappers to authenticate for minor services provided by the application process.

By extending the capability to minor services offered by a primary service, we can provide a greater level of authentication and access control.

By way of example, an authentication service embodiment is provided in Program Listing 3.0. The authentication service is used by the engine service. Thus, we can use tcpwrappers to authenticate for the engine service, and use our own authentication service within the engine, based on the engine component specification. That is to say, when the engine service is configured, we can include the authentication service as a component of the engine. This permits authentication using client Internet Address to determine accessibility to one or more minor services provided by the application service. Alternatively, we could use the domain name associated with the requesting process.

By way of example, an engine component providing input to the engine, can access and interact with the authentication service to determine if the requesting process has appropriate authorization to use the service provided by the input component.

By way of example, an engine component providing preprocessing of input, can access and interact with the authentication service to determine if the requesting process has appropriate authorization to use the service provided by the preprocessing component.

By way of example, an engine component can access and interact with the authentication service to determine an appropriate replacement component for the engine based on the client credentials, which could include the Internet address, the domain name, or other information such as a variable name and value. By way of examples, an information could be “name=c.northrup.” Various variable naming techniques, such as that provided by the KornShell command and programming language could be used. As another example, when a requesting process is executing on a computer within the enterprise (determined by examining the Internet Address of the requesting process), then the authentication service can be used to load a first service to decrypt the input. However, when the requesting process is executing on a computer outside of the enterprise (determined by examining the Internet Address of the requesting process), then the authentication service can be used to load a second service to decrypt the input.

The authentication service can access and interact with other services defined in this specification. By way of example, the authentication service can access and interact with the common directory service to query for accessible services, or for entities providing a service. The authentication service can query for general user information.

The authentication service can access and interact with the services defined in U.S. Pat. No. 5,850,518. By way of example, the authentication service can access and interact with the Thread Directory Service to query for accessible services, or for entities providing a service.

The authentication service can access and interact with a second authentication service based on the requesting process's Internet Address. By way of example, a first service is configured to access and interact with a first authentication service. When a requesting process accesses and interacts with the first service, then the first service accesses and interacts with the first authentication service. The first authentication service determines the requesting process is executing on a computer within the enterprise (i.e., within a given internet address range), and the first authentication service permits full access to the services provided by the first service. When the first authentication service determines the requesting process is executing on a computer outside of the enterprise, then the first authentication service accesses and interacts with a second authentication service to determine if the requesting process is authenticated. By way of example, the second authentication service may use a challenge response method, which is well known in the state of the industry, to verify that the requesting process has appropriate credentials. Alternatively, the second authentication service may configure the first service to use one or more different components such as a different decryption service. Alternatively, the first second authentication service may restrict access to one or more minor services provided by the first service. Alternatively, the second authentication service may cause the first service to access and interact with a second directory service having a different set of registered services. In this manner, when the requesting process is executing within the enterprise, it can access and interact with a first common directory service, but, when the requesting process is executing on a computer outside of the enterprise, it can access and interact with a second common directory service distinct from the first common directory service. Similarly, if the Internet Address of the requesting process cannot be determined, then a third common directory service distinct from the first and second, can be used. In this manner, we can control access to common directory services based on where the requesting process executes, how the requesting process communicates with the first service, or based on the information the requesting process provides to the first service.

As part of the authentication service, the authentication service can access and interact with the common directory service to query for information components. By way of example, if the requesting process provides the authentication service with a unique identifier, the authentication service can access and interact with the common directory service to obtain the registration entry corresponding to the unique identifier. In this manner, the authentication service can configure a service based on the known registration information related to the requesting process.

In this regard, the authentication service provides more than just examining the client Internet Address to determine if the client is allowed access to the primary service. In our invention, the authentication service provides the capability to:

authenticate access to the primary service based on the requesting process's Internet Address

authenticate access to a minor service based on the requesting process's Internet Address

dynamically configure the components of a service, based on the requesting process's Internet Address

dynamically configure the components of a service, based on information provided by a requesting process

access and interact with a common directory service to determine authentication service

access and interact with a common directory service to determine authentication service to use based on requesting process's network access point

select the common directory service accessible to the requesting process based on the Internet Address of the computer the requesting process is executing on.

The authentication service can be implemented to determine the credentials of the requesting process, and determine what service directories should be used to configure the authentication service. By way of example, but not limitation, the authentication service can use reverse domain name lookup to determine the domain name of the requesting process. With that information, the authentication service can then set environment variables, perform initializations, load services, or perform other actions so as to influence the behavior in satisfying the request. In one embodiment, using the Daytona data management system, the environment variable DS_APPS is set to the applications that are permitted (i.e., the associated tables and record class descriptions which collectively define the data being managed). Similarly, the environment variable DS_PATH defines one or more directories to search when looking for the associated service directories (ie., the data being managed).

When a request is made to connect to a service, the request can be sent as components of information (possibly formatted similar to ksh environment variable rules), and using the requesting processes credentials (ie., the Internet domain name associated with the requesting process connection on the client side), we can query the service directory for environment variables and perform the appropriate initialization. A request, such as a command=query description=“report sales for last month” would be queried against a first service directory when coming from a gtlinc domain, whereas the same request sent from a second company with a separate internet domain, would be queried against a second service directory. This method can also be used for registration such that when the request includes:

1. command=register description=“payment information” name=payservice

Then the request will be executed against a service directory identified by the requesting process (client) credentials.

Generic Front End Loading Service

A generic front end loader (gfel) is used to initialize an address space for a service, and access and interact with the service. An example generic front end loader is provided in Program Listings 9.1 through 9.4. Parameters are provided to gfel indicating name/value pairs. When a parameter name is given using the keyword primitive then gfel will register the indicated service with the directory service. As an example, using the parameters:

name=daytime service

location=libservices.so.1.0

primitive=INET

physical=/local:/tmp/ds_comprim

will cause gfel to dynamically load the libservices.so.1.0 library, locate the daytime_service module within the library, and start the service listening on a unix domain socket given by the path name/tmp/ds_comprim.

Alternatively, the parameters

name=daytime_service

location=libservices.so.1.0

primitive=INET

physical=192.168.20.15:9996

will cause gfel to dynamically load the libservices.so.1.0 library, locate the daytime_service module within the library, and start the service listening on a inet socket given by internet address 192.168.20.15 port 9996.

In either case, the service is registered with the directory service.

When gfel is used without the physical name/value pair, then gfel will establish access and interact with the directory service to determine how to access and interact with the service given by the name=name/value pair. As an example, the specification:

name=daytime_service

will cause gfel to access and interact with the common directory service to locate, and to access and interact with the daytime_service.

Using the location and name parameters together, without the primitive or physical parameters, will cause gfel to dynamically load the service into the current gfel process.

An implementation can use the common directory service to determine the appropriate actions for each of the name/value pairs provided to gfel. For example, a specification of:

nvpairs=tds name=route

will cause the gfel to access and interact with the common directory service to determine a name service that gfel can access and interact with, to determine the appropriate actions for using the specification. In this context, the name/value pairs appearing in the specification to gfel, other than nvpairs=tds, are not processed by the gfel process itself, but rather, by a service that gfel will access and interact with. Thus, the remainder of the specification to the gfel process represents arbitrary named representations and gfel has no preconceived notion of what the arbitrary named representations represent. When combining this with the binding service of U.S. Pat. No. 5,850,518, then gfel can use the binding service to determine what the arbitrary named representations represent. In one implementation, gfel may cause binding methods to be registered with the binding service, and then access and interact with the binding service to determine what the name/value pair represents, and how to process it.

When gfel is to execute a service, then gfel will examine the service to determine if the service includes an administrative minor service. If so, then gfel will also accept requests from a requesting process to perform administrative capabilities. Note that gfel will typically use two distinct mechanisms for accepting requests in this regard. By way of example, gfel can accept requests from an administrative communication link such as a Unix domain socket accessible only on the computer that gfel is executing on, and accept general requests from a request communication link such as an Internet socket. By way of example, gfel will open a pathname to a unix domain socket such as /usr/share/gfel/engine/admin and accept administrative requests. Similarly, gfel will open a socket using the Internet Address and specified port to accept general requests for the service. In this manner, even while the primary service offered by gfel is executing, we can connect on the administrative link to access and interact with gfel to perform administrative functions, such as examining the state of gfel, examining the historic use data, reconfiguring the service offered, change logging information, redirecting requests, or otherwise alter the basic behavior of the service without having to terminate and restart the service. This could include, for example, changing the Internet Address and/or port that gfel is using for general access and interaction.

Payment Connection Service

A consumer registers payment service (CPS) which is executing on consumer computer (CC). The registration is with common directory service (CDS). The registration information includes connectivity requirements and consumer the unique identifier (CID). Connectivity requirements can include one or more of: an Internet Address, Port, protocol, access method, communication mechanism, or other information required for CDS to be able to communicate with CPS. Such communication can be communications communicated via computer mail.

A service provider registers requesting service (SPRS) which is executing on service provider computer (SPC). The registration is with common directory service (CDS). The registration information includes connectivity requirements and service provider the unique identifier (SPID). Connectivity requirements can include one or more of: an Internet Address, Port, protocol, access method, communication mechanism, or other information required for CDS to be able to communicate with CPS. Such communication can be communications communicated via computer mail.

SPRS communicates request to CDS. The request is to access and interact with CPS. SPRS provides CDS with SPID and CID.

CDS registers a transaction in progress and assigns the unique identifier (TID). Registration includes TID, SPID, and CID.

CDS locates CPS registration, and communicates the unique identifier (TID) to CPS. CPS receives the unique identifier (TID).

CPS connects to CDS. CPS communicates TID and CID to CDS. CDS locates registration entry for the unique identifier (TID), and CDS facilitates communication from CPS to SPRS. CPS communicates payment information to SPRS.

A first embodiment, Program Listing 14.0, provides a process service which can be included in an engine configuration specification. In this embodiment, the process service receives the tid from the CDS. It then closes the connection from CDS. It then opens a payment_info file, duplicates the file descriptor as file descriptor 0 which is standard input, and calls gfel to connect to the common directory service having the specified tid. The gfel service will invoke the talk2 service which reads from standard input and sends to the connected service.

A second embodiment, Program Listing 14.1, provides a process service which can be included in an engine configuration specification. In this embodiment, the process service receives the tid from the CDS, and also the SPID. It then accesses and interacts with the CDS to query for the registration information related to SPID. In then checks for an information component called Service Provider. If the information component is present, it prompts the user to determine if the user wants to accept the communication request from the specified service provider. If the user does not enter yes, then the connection is declined. Otherwise, the request is accepted and CPS calls gfel to proceed as in the first embodiment. In this embodiment, the name of the service provider requesting payment information would be provided to the consumer. The consumer has the choice to accept or decline. Variations of the embodiment could include the use of a graphic display, or a graphic representation being displayed to the user. By way of example, the user could be presented with a graphic representation of ACCEPT and a DECLINE, and then using a pointing device such as a computer mouse, the user could select the desired option. The software component responsive to the mouse click, would then accept or decline the request for payment information. This could also include displaying the name of the service provider and possibly other registered information related to the service provider. In yet another embodiment, the service provider could communicate the amount due and that information could also be presented to the consumer. In this manner, it would give the consumer a second chance to ensure they agree to the transaction.

When the consumer is using a computer with a monitor, keyboard, mouse, and means of graphical display, that when the CPS is started, it would display a graphical representation indicating that the CPS is running. In a first implementation, this may include a graphical representation such as a wallet being open. When the CPS terminates, the graphical representation would depict a wallet being closed. Customization could include a graphical icon of a purse being open when CPS is running, and a graphical icon of a purse being closed when CPS is not running. In other implementations, when CPS registers with CDS, it can receive a communication representative of a first graphical representation to display when CPS is running. Similarly, it can receive a second graphical representation to display when CPS is no longer running. Note that if a graphical representation is displayed indicating CPS is no longer running, then a component of software can be responsive to the consumer using a pointing device such as a mouse “click”, to cause CPS to start running. In such cases, the graphical representation would then be changed to indicate that CPS is running. In this context, CPS would start executing and would register with CDS. When CPS registers with CDS, it can indicate to CDS that CPS already has graphical representation information and such information would then not need to be provided by CDS.

A third embodiment, Program Listing 14.2, provides a process service which can be included in an engine configuration specification. In this embodiment, the process service receives the tid from the CDS, as well as various acceptable payment types to the service provider. In this embodiment, CPS matches the payment types accepted by the service provider to those recorded in the payment_info file accessed by CPS to match up the information requested with the payment information to be provided by CPS. Multiple variations to the embodiment are possible including implementing a preferred payment type by the consumer in which case CPS would determine if the preferred payment type is accepted by the service provider before choosing other payment types. In another variation to the embodiment, a graphical display may appear on the consumer computer monitor (display) indicating one or more matching payment types, and permitting the consumer to select the preferred payment type for that transaction. In yet another variation, the graphical representation of the various payment types available by the consumer could be displayed, and, when matched against those payment types supported by the service provider, the graphical representation could be changed to a second graphical representation, such as highlighting, to indicate that the payment type is acceptable. The consumer could then depress the mouse button to “click” on one of the highlighted graphical representations to indicate which of the payment types the consumer wishes to use.

In another variation, the CPS could be designed to monitor for communication communicated via computer mail protocol. In doing so, the CPS would register with the CDS that the CDS should communicate pending connections (transactions) to CPS via computer mail. When a computer mail message is received on the CC, the CPS would examine the mail message to determine if it is an appropriate pending transaction communicated from CDS. If so, then CPS would read the unique identifier (TID) and connect to CDS. CPS communicates the unique identifier (TID) and CID to CDS. CDS locates registration entry for the unique identifier (TID), and CDS facilitates communication from CPS to SPRS. CPS communicates payment information to SPRS. Note that once CPS accesses and interacts with CDS, then SPRS could send to CDS other information components that are required.

In another embodiment, CPS could be registered with a common directory service wherein CPS acts as a conduit to a second component of software. In this embodiment, the second component of software could access and interact with a database system to query for payment information and provide same to CPS instead of having CPS open and read an accessible file.

In another embodiment a dual callback system can be used. In this embodiment, SPRS accesses and interacts with CDS to request payment information service for consumer with CID. CDS receives CID and SPID from SPRS. CDS creates a transaction in progress registration and assign a unique identifier (TID). The registration including SPID, CID, and TID. CDS then disconnects from SPRS. CDS uses CID to locate CPS registration, and connects to CPS, and communicates the unique identifier (TID) to CPS. CPS receives the unique identifier (TID). CPS disconnects from CDS and CDS disconnects from CPS. CPS connects to CDS. CPS communicates TID and CID to CDS. CDS locates registration entry for the unique identifier (TID). CDS updates the unique identifier (TID) entry with pending transaction information recording CDS process having CDS connection open. CDS uses SPID of registration entry corresponding to the unique identifier (TID), to locate SPRS entry. CDS connects to SPRS and sends the unique identifier (TID). SPRS receives the unique identifier (TID). SPRS disconnects from CDS and CDS disconnects from SPRS. SPRS calls CDS and sends SPID and TID. CDS, responsive to receiving SPID and TID, locates TID entry. CDS accesses and interacts with pending transaction information of the recorded CDS process having CDS connection open to pass file descriptors to said CDS process. CDS then notifies recorded CDS process to facilitate communications. CPS then communicates payment information to SPRS.

Note that the method of the payment service can be used to facilitate other such services. By way of example, CPS could be a contact service providing consumer contact information. In such cases, the SPRS would be requesting access to the contact service instead of the payment service for the specified consumer. SPRS could provide to CPS the information component name or names that it is looking for. CPS could then fill in the response. The CDS would facilitate communication just as it does for the CPS providing payment information.

Alternatively, CPS could be corporate information such as that which would normally appear in a Dunn & Bradstreet (D&B) report. In such cases, the SPRS would be requesting access to the corporate information associated with a particular the unique identifier. Thus, the SPRS could send the desired service type for a particular the unique identifier to CDS, and CDS could locate the service and facilitate the connectivity as described in this specification.

A Data Sharing Service

A first process of a first computer of the network accesses and interacts with a directory service to register the first process as providing a particular type of data, such as an Excel spreadsheet template, an Excel spreadsheet formula, an encoded voice stream, a video stream, voice and video stream, genealogy information, medical records information, financial data, or the like. The registration information includes the connectivity required to reach the service. The registration information could also include one or more of the registration information components described in U.S. Pat. No. 5,850,518, such as the input types understood by the service, the output types, or the data representation used in communicating with the service. The first process listens for a request. By way of example, the first process could register a description of “northrup genealogy” and connectivity information of “elmer.gtlinc.com:9999” where elmer.gtlinc.com is the name of a computer within the gtlinc.com domain, and 9999 represents the port that the first process is listening on. Using standard name services, the registration process can convert the name elmer.gtlinc.com to an Internet Address, or the, the directory service can use the domain name service to determine the Internet Address when needed.

A second process of a second computer of the network accesses and interacts with the directory service to request access to the first service. By way of example, the second process could provide criteria description=“northrup genealogy”. The directory service, responsive to receiving the request, locates the first service registration entry and accesses the registration entry. The directory service then facilitates the connectivity to the first service.

The invention is not limited to data stream processing. The underlying communication could be implemented through various protocols and various communication methods such as through sockets.

Medical Test Results Reporting Service

HIPAA (Health Insurance Portability and Accountability Act of 1996) regulations have been put into law which clearly define the treatment of patient information by health care providers. These regulations cover both patient privacy standards as well as security standards that the health care provider must adhere to with respect to digital patient data.

Medical test results reporting can be automated within the HIPAA regulations via a service. The service can be provided by the health care provider, or by a third party service provider.

The health care provider summarizes the results of medical tests in a format to be made available to the patient. This may include an image scan of a printed lab report, physician notes, or other means of documentation. In a preferred embodiment, the scan images would be saved in an industry standard file format such that a viewer can be used to view the images (hardware to provide same and software is provided by Hewlett Packard's ScanJet Scanner). This information is then recorded in a data store.

The medical test results in the data store are encrypted with a digital key that is stored and will be made available only to the patient. Alternatively, just prior to providing the results, the software service will encrypt the data from the data store according to the patient digital key.

The health care provider notifies the patient that the medical test results are available. Such notification can be via telephone, email, or other means such as software notification.

The health care provider communicates the unique id of the results to the patient.

The patient registers with the health care provider service and receives a unique id (PID). This must be completed before the patient can retrieve the test results.

The patient becomes aware of the availability of the test results. Using the PID and the unique id of the test results, the patient connects to the service and retrieves the medical test results.

In a first embodiment, the Health Care Provider (HCP) maintains computer (HCC) with communication device. The HCP provides a directory service (HDS) executing on HCC. HCP registers patient with directory service and patient is assigned a unique identifier (PID). The HCP registers a service to provide lab test results (HCLRS) to patient (PID). The registration is assigned a unique identifier (TID), and the registration records PID. HCP communicates the unique identifier (TID) to patient with PID. Patient with PID uses computer (PCC) with a communication device, to start a first process on PCC. The first process accesses and interacts with HDS. The first process provides PID and TID to HDS. HDS locates the TID entry, and facilitates connectivity to HCLRS. HCLRS, responsive to the connectivity, provides first process with medical test results. The first process uses the digital key known to patient with PID to decrypt the results, and display the results to the patient.

In a second embodiment, the Health Care Provider (HCP) maintains computer (HCC) with communication device to permit communication with the network. The HCP provides a directory service (HDS) executing on HCC. HCP registers patient with directory service and patient is assigned a unique identifier (PID). Patient with PID maintains and uses computer (PCC) with communication device to permit communication with the network. Patient causes software service PSS to begin executing on PCC. PSS accesses and interacts with HDS to register PSS and connectivity required to reach PSS.

The HCP registers a service to provide lab test results (HCLRS) to patient (PID). The registration is assigned a unique identifier (TID), and the registration records PID. HCLRS accesses and interacts with HDS, causing HDS to locate PSS entry, access PSS entry, and to access and interact with PSS. HDS provides PSS with the unique identifier (TID). PSS accesses and interacts with HDS, providing HDS with PID and TID. HDS locates the registration entry with PID and TID, and facilitates connectivity to HCLRS. HCLRS, responsive to the connectivity, provides first process with medical test results. The first process uses the digital key known to patient with PID to decrypt the results, and display the results to the patient.

In a third embodiment, the Health Care Provider (HCP) maintains computer (HCC) with communication device to permit communication with a network. The HCP uses a component of software to register with a common directory service executing on a second computer of the network. HCP is assigned a unique identifier (HCID).

Patient uses a computer PCC with communication device to permit access to network. Patient causes a component of software to be executed and patient registers with common directory service. The registration including a unique identifier (PID) uniquely qualifying the patient from other registered patients.

Patient causes software service PSS to begin executing on PCC. PSS accesses and interacts with common directory service to register PSS and connectivity required to reach PSS.

The HCP registers a service to provide lab test results (HCLRS) to patient (PID). The registration is assigned a unique identifier (TID), and the registration records HCID and PID. HCLRS accesses and interacts with common directory service, causing common directory service to locate PSS entry, access PSS entry, and to access and interact with PSS. PSS is provided the unique identifier (TID). The access and interaction now complete, and the common directory service disconnects from the communication with PSS.

PSS accesses and interacts with common directory service, providing common directory service with PID and TID. The common directory service locates the registration entry with PID and TID, and facilitates connectivity to HCLRS. HCLRS, responsive to the connectivity, provides medical test results. The PSS uses the digital key known to patient with PID to decrypt the results, and display the results to the patient.

In a fourth embodiment, the Health Care Provider (HCP) maintains computer (HCC) with communication device to permit communication with a network. The HCP uses a component of software to register with a common directory service (CDS) executing on a second computer of the network. HCP is assigned a unique identifier (HCID).

Patient uses a computer PCC with communication device permitting access to network. Patient causes a component of software to be executed and patient registers with CDS. The registration including a unique identifier (PID) uniquely qualifying the patient from other registered patients.

Patient causes software service PSS to begin executing on PCC. PSS accesses and interacts with CDS to register PSS, the registration including PID and connectivity required to reach PSS.

The HCP uses a component of software to register with CDS, a service to provide lab test results (HCLRS) to patient (PID). The registration is assigned a unique identifier (TID), and the registration records HCID and PID.

CDS locates PSS registration entry having PID and PSS, access the entry, and connects to PSS. CDS communicates the unique identifier (TID) to PSS. CDS disconnects from PSS communication link.

PSS connects to CDS, and sends PID and the unique identifier (TID).

CDS, responsive to receiving PID and TID, locates the registration entry with PID and TID, and connects to HCLRS. CDS uses file descriptor passing techniques to pass the file descriptor of HCLRS to PSS.

HCLRS encrypts medical test results and sends the results to PSS. PSS receives the results, and uses the digital key known to patient with PID to decrypt the results, and displays the results to the patient.

Alternatively, the health care provider may choose to use a third party to host the reporting service. Using this method, the provider posts the availability notice to the third party provider, who in turn notifies the patient of the availability. When ready to retrieve the results, the patient service connects to the third party service, which in turn then connects to the health care provider. During the ensuing transaction, the patient service is delivered the results of the lab tests.

Physician Pharmaceutical Service

A pharmacist uses a computer (PCC) with operating system with interfaces for communication connectivity and synchronization, and a communication device, to execute a component of software which registers pharmacists with common directory service (CDS) running on a second computer of the network. The pharmacist is assigned a unique identifier (PHARMD).

A doctor uses a computer (DCC) with operating system with interfaces for communication connectivity and synchronization, and a communication device, to execute a component of software which registers doctor with CDS and is assigned a unique identifier DID.

A patient is registered with CDS and is assigned a unique identifier PID. The patient could uses a computer (HCC) with operating system with interfaces for communication connectivity and synchronization, and a communication device, to execute a component of software which registers patient with CDS and is assigned a unique identifier PID. Alternatively, the doctor or an assistant thereof can register patient with CDS.

The doctor prescribes a prescription for patient and records the prescription in a data store.

The doctor uses computer to execute a component of software (MDS) to provide PID prescription information. MDS connects to CDS and registers as a service, the registration including the connectivity required to reach the service, and the DID.

The patient visits PHARMD office and provides PHARMD with their PID, and their doctor's name (or DID). The pharmacist uses a component of software (COS) on PCC to connect to CDS and request prescription information for patient PID, the request including the DID (or doctor's name).

CDS registers the request as a pending transaction and assigns the unique identifier (TID), the registration including DID and PID.

CDS uses DID as criteria to locate MDS registration and connects to MDS. CDS sends TID to MDS. MDS receives TID. CDS and MDS disconnect. MDS connects to CDS and provides TID and DID. CDS locates the unique identifier (TID) entry and facilitates communication to COS. MDS then provides COS with prescription information.

In a preferred embodiment, the prescription information would be encrypted according to a digital certificate. In this manner, when MDS provides the prescription information, the information would be encrypted. It is noted that COS would need to decrypt the information. In one embodiment, the digital certificate would be that of the pharmacist. In a second embodiment, the digital certificate would be assigned and known to the patient. In a third embodiment, the digital certificate would be known to the doctor. In any case, the doctor software MDS would need to have access to the digital certificate, as would the COS.

Data Store Forwarding Service

A challenge with software services is that the corresponding process must also be accessible to the network. There are times, however, when due to power failures, network interruptions, scheduled down time, and the other situations, where the computer or the corresponding process may not always be accessible via the network.

When the service is to provide a stream of data, it is desirable to offer that data even if the host computer is not accessible. To resolve this limitation, a recording service is provided, along with a playback service.

This permits a first process of a first computer of the network, to connect to a recording service to record data provided by the first process. The recording service will record the data to a data store, and assign a unique name to the data. By way of example, a unique file name can be used when the data store is a standard file. A playback service, given the unique name to the data, can access and playback the data to a requesting process.

The recording service can be a first process of a first computer of the network, listening for requests on a network endpoint, such as an Internet Address and port. The recording service accepts a connection from a requesting process, and records whatever the requesting process sends, to a data store, such as a file. The file is uniquely named. The recording service can be registered with a common directory service running on a second computer of the network. Program Listing 14.3 provides an embodiment of a recording service process for a software engine, or for use with gfel.

The playback service can be a third process of the first computer of the network, listening for requests on a given network endpoint, such as an Internet Address and port. The playback service accepts a unique name, accesses and interacts with a data store defined by the unique name, and communicates the contents thereof. The playback service can be registered with the common directory service. Program Listing 14.4 provides an embodiment of a recording service process for a software engine, or for use with gfel.

By connecting to the recording service, a requesting process can retrieve a unique file name, and can send data to be recorded by the recording service. The playback service can be registered with the common directory service. A second requesting process can then connect to the common directory service to locate the playback service, and can provide the playback service with the specified unique file name. The second requesting process would then receive the contents of the data previously recorded by the recording service.

In an alternative embodiment, the playback service could erase the contents of the data store given by the unique identifier after the playback has occurred. Similarly, the playback service could connect to the common directory service and cause the registration entry for the playback service to be deleted.

In an alternative embodiment, the playback service can determine the data type by examining the content of the data, in order to determine playback modes. By way of example, this would be comparable to using a mime type to determine the playback software that is to be used.

Academic Transcript Service

School grades are considered private information, and cannot be disclosed to third parties. Providing current grades and academic transcripts via the world wide web is less then secure in the current state of the art. To address this concern, an Academic Transcript Service is provided.

An educational institution uses a computer with communication device and an operating system with interfaces for communication connectivity and synchronization (ACC) to access network.

A student is registered with common directory service and assigned a unique identifier (SID).

The academic institution is registered with the common directory service and assigned a unique identifier (AID).

A student uses a computer with communication device and an operating system with interfaces for communication connectivity and synchronization (SCC) to access network.

The Academic Institution runs an academic reporting service (ARS) on ACC. ARS registers with common directory service, the registration including connectivity requirements to reach ARS.

The student executes a component of software (RADAR) on SCC, the component of software designed to request and display academic records. The student provides RADAR with SID. RADAR connects to the common directory service and request academic records for SID. The common directory service receives the request and records SID and AID into a transaction registration entry, the transaction being assigned a unique identifier (TID). CDS connects to ARS and sends the unique identifier (TID). ARS receives TID and both ARS and CDS disconnect from the communication. ARS then connects to CDS and provides AID and TID. CDS, responsive to receiving AID and TID, locates the corresponding transaction entry and facilitates connection to RADAR. ARS provides RADAR with academic transcripts, and RADAR receives and processes the academic transcripts.

In a second embodiment, student is registered with CDS and assigned SID. The academic institution is registered with CDS and assigned AID. The Academic Institution runs an academic reporting service (ARS) on ACC. ARS registers with common directory service, the registration including connectivity requirements to reach ARS.

RADAR begins executing on SCC. Student provides RADAR with SID. RADAR registers with CDS, the registration including SID and connectivity required to reach RADAR.

RADAR connects to CDS and request academic records, for SID. The request can include AID or academic institution name which can be used to locate AID. CDS registers the request as a transaction in progress and assigns a unique identifier (TID). The registration entry can include AID. CDS and RADAR then disconnect.

CDS locates ARS entry, connects to ARS, and sends TID. ARS receives TID. Both CDS and ARS disconnect.

ARS connects to CDS. ARS sends AID and TID to CDS. ARS receives from CDS, the SID. ARS uses SID to access and interact with datastore having academic transcripts. ARS accesses the transcripts.

CDS, responsive to receiving AID and TID, locates RADAR registration entry using SID as the lookup value. CDS creates registration entry for active ARS session, and assigns a unique identifier ATID. CDS connects to RADAR and sends RADAR the ATID. RADAR receives ATID. RADAR and CDS then disconnect from the communication link.

RADAR connects to CDS and sends ATID and SID. CDS, responsive to receiving ATID and SID, locates registration entry and facilitates communication connectivity between RADAR and ARS. ARS then communicates academic transcripts. When complete, RADAR, ARS, and CDS all disconnect from the communications.

Public Office Election Service

Many have considered using the Internet for general elections. The belief is that more registered people would participate in the voting if permitted to vote over the Internet, instead of driving to drive to a local school. The challenge, of course, is the lack of security and the mechanisms to institute elections over the Internet. To address this concern, an election service is provided.

An election office, or appropriate authority, uses a computer with communication device and an operating system with interfaces for communication connectivity and synchronization (ECC) to access network.

A registered voter is registered with common directory service and assigned a unique identifier (VID).

The authorizing agency is registered with the common directory service and assigned a unique identifier (EID).

A voter uses a computer with communication device and an operating system with interfaces for communication connectivity and synchronization (VCC) to access network.

The authorizing agency runs an election service (ES) on ECC. ES registers with common directory service (CDS), the registration including connectivity requirements to reach ES.

The voter causes software (VCS) to execute on VCC. VCS connects to CDS and request access to voting information. CDS locates ES registration entry, and facilitates communication connectivity on behalf of VCS to ES.

ES provides VCS with voting information. The information containing candidate information. The information could contain instructions. The information could contain additional information such as political party, desired office, the term of office, or other such information as would be useful to the voter. Once complete, ES, VCS, and CDS all disconnect from the various communication links.

VCS requests VID from voter. The voter provides VID to VCS. The voter also selects the desired candidate (either through mouse click, pointing device, touch screen, voice, keyboard, keypad, or other mechanism as one skilled in the state of the art would understand, or via an industry standard method for providing input to a software service).

VCS connects to CDS and request access to ES. VCS provides CDS with VID. CDS creates a transaction in progress registration entry and assigns a unique identifier (TID). The registration entry including connectivity information required to reach VCS. VCS then disconnects from CDS. CDS connects to ES and provides ES with the unique identifier (TID). ES receives the unique identifier (TID). ES and CDS disconnect.

ES connects to CDS and provides EID and TID. CDS locates TID entry. CDS uses connectivity information to connect to VCS and provides VCS with TID. VCS receives TID. CDS and VCS disconnect. VCS connects to CDS and provides VID and TID. VCS locates TID entry and facilitates communication connectivity on behalf of VCS to ES. VCS then provides ES with voter supplied information.

Medical Records Service

Extensive, accurate and up-to-date medical records may not always be available in times of urgent need. A Medical Records Service provides a means to make an individual's complete medical record available to a health care provider while controlling access and ensuring privacy.

To use the service, the patient registers with the third party Medical Records Service, creating a common directory service (CDS) entry for the patient and obtaining a unique identifier (PID). The entry also includes a limited-use personal identifier (LUPID).

Health care providers interested in using the service also register with CDS, creating a CDS entry and obtaining a unique identifier (HCPID).

The health care provider registers with CDS, a Health Care Reporting Service (HCRS) executing on health care provider's computer having a communication device and an operating system with interfaces for communication connectivity and synchronization. CDS creates a registration entry and assigns the unique identifier HCRSID.

When a patient visits a health care provider, the health care provider creates a record in CDS indicating that care has been provided for that patient. Medical records are not stored in CDS, it contains only a record of the relationship between the patient with PID and the provider with HCPID.

When the medical records for a patient need to be referenced (by an emergency room staff, for example), the patient consents by providing the inquiring party with PID and LUPID. It is noted that the inquiring party must also be registered with CDS and have a unique identifier (IPID).

The inquiring party uses a component of software (COS) on a computer having a communication device and an operating system with interfaces for communication connectivity and synchronization to request medical records for patient with PID and personal identifier LUPID. CDS receives the request and creates a transaction in progress registration entry, assigning a unique identifier (TID). CDS accesses the registered entries for PID to determine HCPID.

CDS uses HCPID to lookup the health care provider HCRS service. Once located, CDS connects to HCRS and sends the unique identifier (TID). HCRS receives the unique identifier (TID) and disconnects, as does CDS. HCRS then connects to CDS and provides HCPID and TID. CDS receives HCPID and TID, and locates corresponding registry entry for TID. COS then facilitates communication connectivity with COS. HCRS then sends to COS the records for patient PID.

In a preferred embodiment, the communicated patient medical records would be encrypted according to a certificate. The certificate would have to be known by either the Health Care Provider and the inquiring party, in order to decrypt the data. In one embodiment, the certificate could be the LUPID, as it is available to all parties. In a second embodiment, the certificate could be the PID, or the HCPID, or the IPID. In any case the certificate for public key encryption or the equivalent thereof, must be known by the corresponding parties.

Resume Matching Service

Due to privacy concerns, it is not always desirable to post one's resume on public bulletin boards or job posting sites. Likewise, it is expensive for employers to use employment agencies, classified advertisements and job websites to post job openings. A resume matching service provides a private, secure method of matching job applicants to companies with job openings.

Individuals register with a third party that provides the service. The registration is anonymous. Registration includes job history, education and other typical data included on a resume.

Companies register with a third party that provides the service. The registration is not anonymous. Companies provide such information as company background, location, benefits, etc. that are of interest to job seekers.

When a company has a job opening, the description of the job is posted to the directory service. Details include job title, salary, education requirements, location, start date, etc.

When individuals wish to search for job openings, they connect to the directory service and indicate availability, along with salary requirements. The resume matching service scans available job postings by companies and matches the job seeker's data to the job opening. Matches are retrieved and sent to the individual for review. The individual scans the job openings, along with the company information posted in the directory service. Each job opening is either rejected or accepted. When a job opening is accepted, the service is contacted, and the individual's resume is sent to the company, along with personal contact information for the individual. When there is a mutual interest, a job interview is scheduled.

Company Credit Reporting Service

Obtaining credit information on potential customers is useful prior to establishing credit terms. Although commercial services are available to obtain such information, the cost may be prohibitive for many businesses. An alternative Credit Reporting Service makes this possible.

Companies register with the third party Credit Reporting Service, creating a directory service entry and obtaining a unique identifier. Registration indicates the company's participation and willingness to share data on their credit history with other companies.

Companies also register entries in the central directory service indicating those other companies with which they have done business. Companies contribute their own credit experience with other companies to their own Credit History Service, which can be accessed via the central directory service.

Third party services provided value-added services such as public records reporting, credit scoring, etc., for a fee for specific queries against the central directory service.

A Prepay Service

Various payment methods have been used for electronic commerce. The prepay service is a method for maintaining secure payment information.

A consumer uses a computer with communication device and an operating system with interfaces for communication connectivity and synchronization to execute an APS component of software. The consumer interacts with APS to provide registration information. APS registers consumer with common directory service (CDS), and consumer is assigned a unique identifier (CID).

A service provider uses a computer with communication device and an operating system with interfaces for communication connectivity and synchronization to execute a PS component of software. The service provider interacts with PS to provide registration information. PS registers service provider with common directory service (CDS), and service provider is assigned a unique identifier (SPID).

Service provider causes PS to execute and PS accesses and interacts with CDS to register as a prepay service, the registration including connectivity requirements to reach PS.

Consumer uses APS to prepay services. APS accesses and interacts with CDS to locate prepay service PS. Consumer specifies the amount of prepaid service desired. Consumer uses payment service described elsewhere in this specification to pay for the prepaid service. By way of example, consumer authorizes $50 prepaid service to be billed to consumer's American Express credit card. The prepay service (PS) receives payment information and causes the consumer's American Express account to be billed $50. The prepay service (PS) registers the credit with a directory service, the registration including the CID, the outstanding credit amount, and a unique identifier (ANID). The prepay service sends the ANID to APS. APS receives the ANID and records in the payment information file a prepaid payment type and account ANID.

In subsequent uses of the payment service, the service provider receiving the payment information would access and interact with CDS to locate the prepay service. Once located the service provider software would then request a debit to the ANID account for CID. The prepay service would provide service provider with a separate authorizing payment information to bill against. In a preferred embodiment, this would include a mastercard account, expiration date, and cardholder information.

In an alternative embodiment, the consumer payment service (CPS) would receive the bill amount from SPRS. CPS can access and interact with CDS to locate prepay service and send ANID, CID, and bill amount to prepay service. The prepay service, responsive to receiving ANID, CID, and bill amount, would locate registration entry for ANID and would authorize payment of bill amount to credit card held by service provider. In doing to, the prepay service would communicate the payment information (i.e., card holder, credit card type, credit card number, credit card expiration) to CPS which would then communicate that information to SPRS.

In an alternative embodiment, the prepay service would be used in place of the CPS. This, however, requires registration with CDS to indicate that prepay service should be used for providing payment service for CID. In such cases, it is preferable for the prepay service to make such registration information available to CDS. Thus, when SPRS request payment information service for CID to CDS, then CDS would record the unique identifier (TID) and communicate the CID and TID to prepay service, and prepay service would validate the CID and provide payment information to SPRS. This would permit the prepay service to provide SPRS with a temporary credit card with a preset limit not to exceed the balance due to the service provider SPID.

Translation Service

Language translations such as Japanese to English or vice-a-versa, are often desirable. The google search engine offered at http://www.google.com provides a translation service for cached HTML documents. When a user of the network receives email in a foreign language, there are no translation services via the Internet to provide translation from a first language to a second language. Similarly, there are no services to translates from a first language to a second language when sending email. Yet electronic mail is one of the most widely used services of the Internet.

A service provider can register with common directory service (CDS) and is assigned a unique identifier (SPID). The service provider provides a language translation service (LTS) component of software on service provider computer (SPCC). The service provider causes LTS to execute on SPCC. LTS registers with CDS. The registration including the connectivity required to reach LTS.

A consumer can use a component of software (COS) on consumer computer (CC) to register with CDS. The consumer is provided a unique identifier (CID).

The consumer can use a component of software (SCOS) on consumer computer (CC) to request CDS to connect with a language translation service providing translation from English to Chinese. CDS locates LTS registration entry, and creates a transaction in progress registration entry, assigning a unique identifier (TID). CDS connects to LTS and sends TID to LTS. LTS receives TID and disconnects from CDS, as well as CDS disconnecting from LTS. LTS connects to CDS and provides SPID and TID. CDS locates TID entry and connects LTS to SCOS.

In this manner, SCOS can communicate information to LTS which is to be translated from English to Chinese. When complete, LTS, SCOS, and CDS all disconnect from the communication.

Note that in a first embodiment, CDS could provide SCOS with the connectivity required to reach LTS independent of CDS. In a second embodiment, CDS can disconnect after the connection has been made between LTS and SCOS. In a third embodiment the data representation to be communicated to LTS may require translation from a first format to a second format. In this manner, various brokers can be dynamically loaded to provide such translation. By way of example, if SCOS is communicating an unformatted component of an electronic mail message to be translated, and LTS requires the format to be HTML, then a broker service can be used to provide translation for the unformatted text to be formatted according to HTML rules. Similarly, the results of LTS may be communicated in HTML format. Thus, a broker service can be used to provide translation from HTML format to unformatted content.

An Environment Service

An environment service starts out as a process essentially representing a vacuum, such as empty space. There are no objects, no services, nor anything of interest in the environment.

A requesting process having appropriate authorization can connect to the environment service and specify that a service is to be executed within the environment, the service being a controlling service, in which case, the controlling service acts as the administrator of the environment.

A requesting process having appropriate authorization, can connect to the environment and induce a behavior by requesting a first service to be executed within the environment. The controlling service accesses and interacts with the directory service to locate the desired first service and causes the service to effect the environment. By way of example, this can include loading the service and executing the service as a thread. Alternatively, the controlling service could connect to the first service and communicate with the service. The controlling service registers the first service in an environment directory service (registry).

A requesting process having appropriate authorization, can connect to the environment and induce a behavior by requesting a second service to be executed within the environment. The controlling service accesses and interacts with the directory service to locate the desired second service and causes the second service to effect the environment. By way of example, this can include loading the service and executing the second service as a second thread. Alternatively, the controlling service could connect to the second service and communicate with the second service. The controlling service registers the second service in an environment directory service (registry).

The first service and the second service can compete for computing resources, discover each other through querying the environment directory service, and otherwise interact with each other as deemed appropriate. Alternatively, the controlling service can determine the interactions between the first service and the second service, or otherwise assist in their influencing their behavior.

By way of example, a first service can represent an atom, such as a hydrogen atom. A second service can represent an atom such as an oxygen atom. A third service can represent a second oxygen atom. When the controlling service recognizes the atoms and has means to bind the atoms, then the controlling service can induce a fourth service representative of a water molecule, and cause the first, second, and third service to be suspended, as they are now part of the fourth service. Alternatively, the first, second, and third service may be able to execute, but only within the environment of the fourth service. In such cases, the controlling service would create a new environment and register the first, second, and third service within that environment. By way of example, the controlling service creates a new directory service registry and moves the first, second, and third service registration from the current environment registry to the new directory service registry. The controlling service may also suspend, or otherwise lower the priority values of the services are deemed appropriate. When the embodiment includes multithreading, then the priority value of the thread may be set. When the embodiment includes single threading, then the priority value of the process may be set.

The controlling service can use Virtual Reality Modeling Language (VRML), which uses the right-handed Cartesian Coordinate System. Accordingly, a first service can have a current location within the environment. Note that VRML is well understood in the state of art. VRML was recognized as an international standard (ISO/IEC-14772-1:1997) by the International Organization for Standardization (ISO) and the International Electrotechnical Commission (IEC) in December, 1997. Alternatively, as new industry standards for virtual modeling emerge, such standards could be used.

A service can induce the effect of wind or air movement to change the coordinate of one or more services within the environment. The coordinate of a service within the environment can be maintained with the environment directory service.

A service can induce the effect of heat or cold. By inducing the effect of heat within a given coordinate range, the service can register the current heat value with the controlling service, which could query the environment registry to determine which services would be effected by the heat, and notify the services accordingly. The controlling service can use multiple services to assist in controlling the environment. By way of example, a temperature service can be a service of the controlling service. When the controlling service receives notification of heat within a given coordinate range, the controlling service can communicate that information to the temperature service which then access the environment registry to determine the effected services.

A service within the environment can simulate motion. In doing so, the service would have a velocity and a path. The service could update the current coordinates with the environment registry as appropriate. In an alternative embodiment, the service can maintain the current coordinates, and the controlling service could query the service to determine the current coordinates.

Although alternative embodiments could languages other than VRML, having the standard VRML permits third parties to create services and register the services with the environment service.

A consumer of the environment service can use a component of software on the consumer computer to connect to the environment and receive the current state of the environment. In such cases, the component of software may need to render graphic images or otherwise understand what the state of the environment, as communicated by the environment service, represents. In an alternative implementation, the component of software could access and interact with a broker service which understands how to interpret the state of the environment, and which can communicate the information to the consumer component of software in a manner understood by the component of software. By way of example, the broker service could convert the output of the environment service to a multimedia presentation and communicate the multimedia presentation to the consumer component of software.

The implementation does not need to used the atomic level of modeling. By way of example, a virtual landscape such as a virtual mall, a tour, or other landscape could be used as well.

The implementation could also be used for genetic sequencing, medical discoveries such as drug interactions, or other types of services in which one needs to understand the interactions between two or more entities within an environment.

Note that the environment could use ADAM, A Dynamic Attribute Manager, as described in Programming With UNIX Threads, C. Northrup, John Wiley and Sons, ISBN 0-471-13751-0, to implement multithreading of services within the environment. A modification of ADAM as a service is defined elsewhere in this specification.

Typical Embodiment

A typical embodiment includes consumer computer, which can be a HP Pavilion running Windows 98, with Internet access via an Internet Service Provider. Internet access is typically via an analog modem for dial-up access, or via high-speed broadband DSL, cable or fixed wireless service. The service provider computer(s), which can be a workgroup class server such as a Sun Enterprise 450 Server running the Solaris operating system, with dedicated access to the Internet via an Internet Service Provider. This access is typically a high-speed service such as Frame Relay, DS-1 or DS-3 service. The service provider computer(s) typically have large amounts of disk storage either internal or in external disk arrays. The directory service computer(s) is typically a midrange system such as a Sun Enterprise 3500 multiprocessor server running the Solaris operating system, configured with dedicated access to the Internet via an Internet Service Provider. This access is typically a high-speed service such as Frame Relay, DS-1 or DS-3 service. The directory service computer(s) typically have large amounts of disk storage either internal or in external disk arrays. The actual computers in use will be determined by processing requirements. In extremely high-volume processing environments clusters of server computers may be used by the service provider or the directory service.

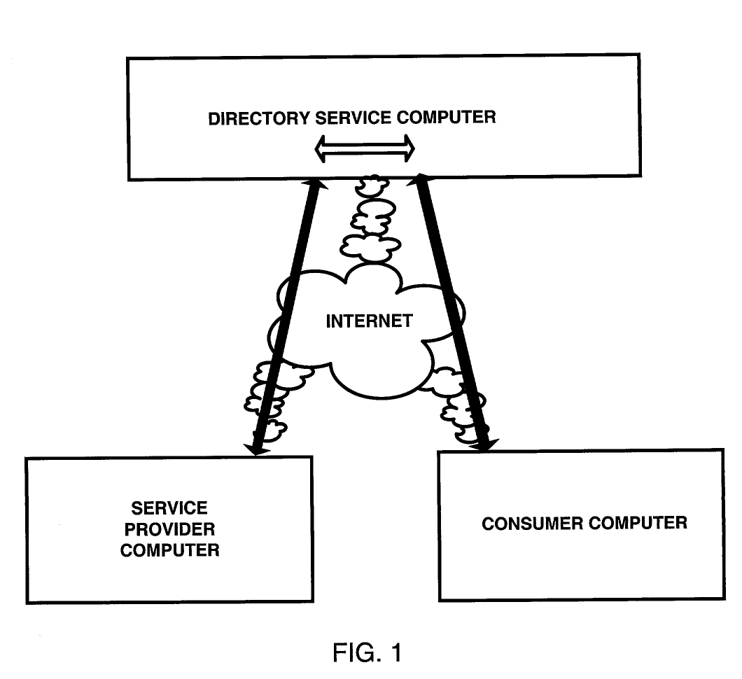

FIG. 1 is a diagram of a computer network communicating according to the present invention. A directory service computer 31 is connected to a service provider computer 23 and a customer's computer 32 via the internet, represented at 37. FIG. 1 provides an illustration of such an embodiment. Note that each computer has at least one communication device, such as a modem or an Ethernet card; a monitor display such as a Philips Magnavox; an input device such as a keyboard; a pointing device such as a Microsoft Mouse, or other appropriate mouse for the configuration; an operating system, such as Linux, AIX, HP-UX, Microsoft Windows 98, NT, 2000, XP, or other Microsoft Windows operating system, Solaris, Irix, Linux, Unix, BSD, Free-BSD, OS/390 or other commercially available operating system for the architecture. Alternatively, the operating system could be one provided by academia, open source, or other such operating system.

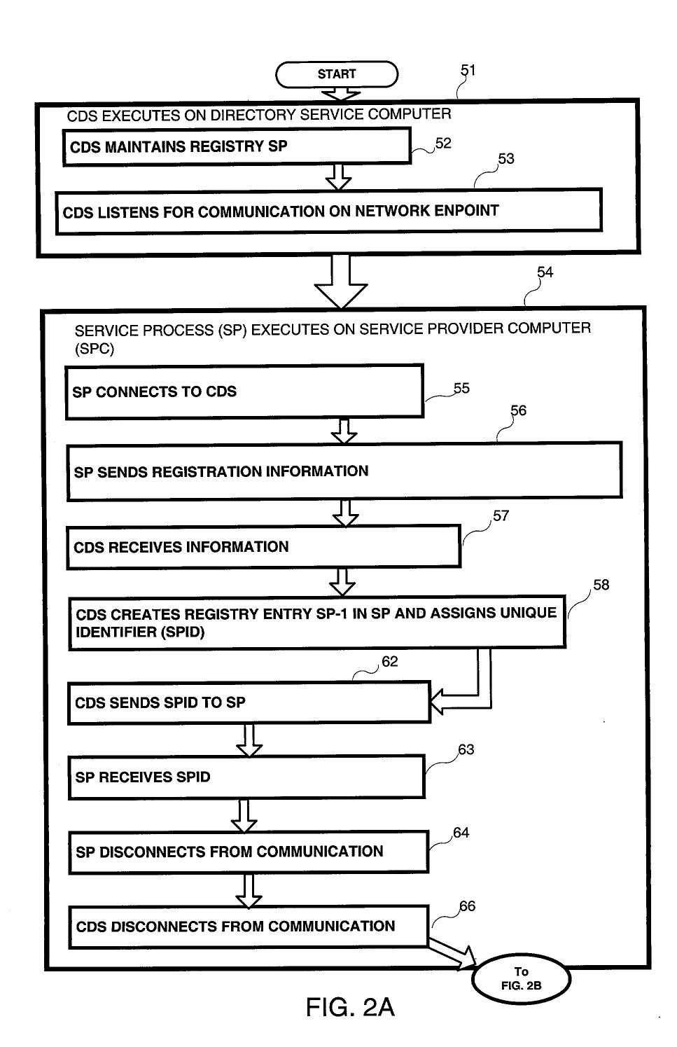

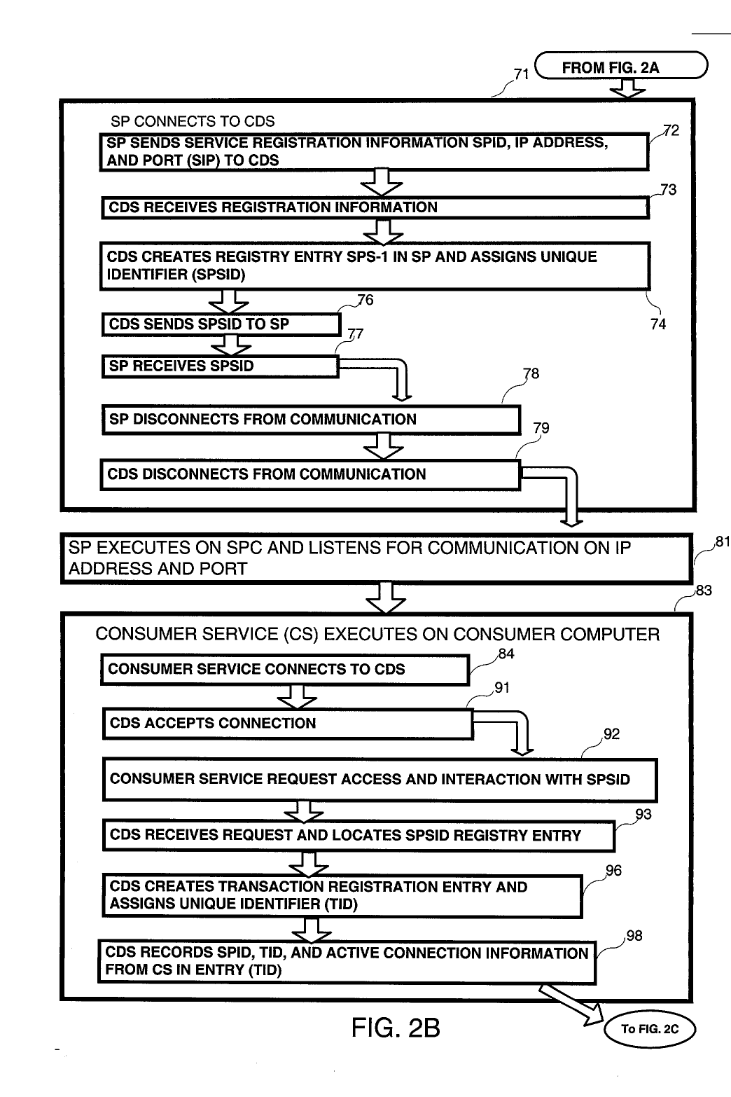

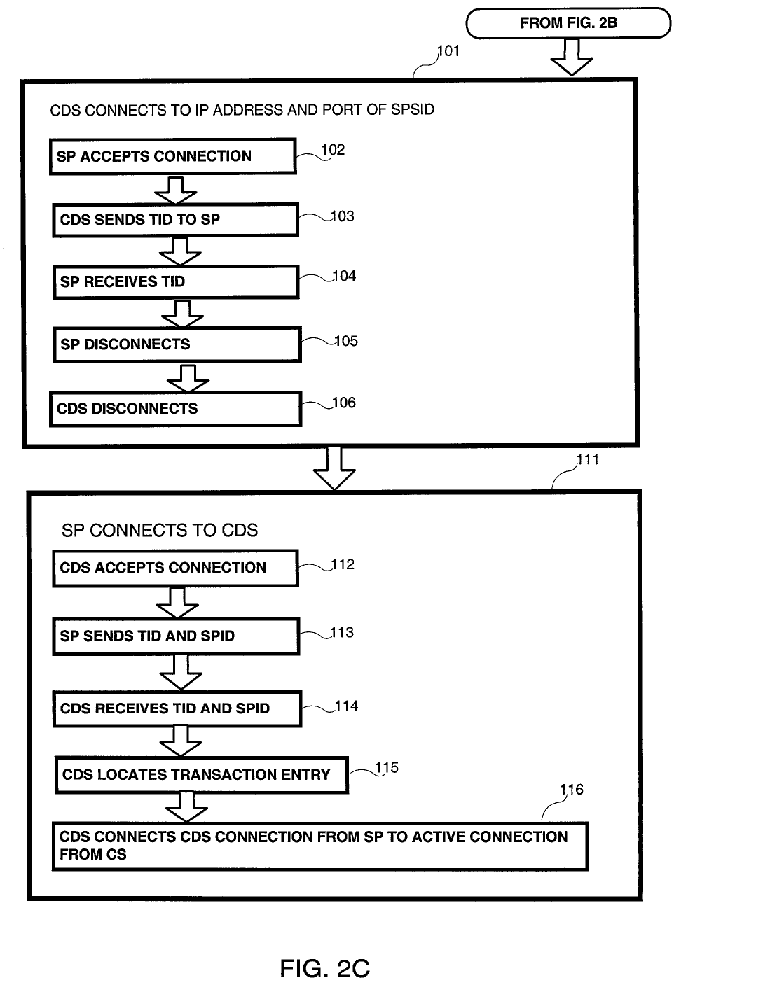

Processing flow embodiments are provided in FIGS. 2-7, showing the order of the processing to use the invention.

FIG. 2 is a flowchart of a directory service connection service. In step 51, a common directory service (CDS) executes on a directory service computer (31, FIG. 1). The common directory service maintains 52 registry SP, and listens 53 for communication on network endpoint. A service process executes 54 on a service provider computer (32, FIG. 1), and then connects 55 to the common directory service, and sends 56 registration information to the common directory service. CDS creates 58 a registry entry SP-1 in registry SP and assigns a unique identifier SPID. The common directory service sends 62 the SPID to the service process, and the service process receives 63 the SPID, followed by the service process disconnecting 64 from communication. This results in the common directory service disconnecting 66 from communication.

After the common directory service disconnects 66 from the communication, the service process connects 71 to the common directory service, and sends 72 service registration information, SPID, IP address, and port (SIP) to the common directory service, and the common directory service receives 73 registration information. At this point, the common directory service creates 74 registry entry SPS-1 in the service process and assigns a unique identifier (SPSID). The common directory service sends 76 the SPSID to service process, and the service process receives 77 the SPSID and disconnects 78 from communication. This is followed by the common directory service disconnecting 79 from communication.

When the common directory service disconnects 78 from communication, the service process executes 81 on the common directory service and listens for communication on IP address and port. A consumer service executes 83 on consumer computer (33, FIG. 1), and connects 84 to the common directory service.

The common directory service accepts 91 a connection by a consumer service requesting 92 access and interacting with SPSID, receives 94 a request and locates the SPSID registry entry. The common directory service receives 93 the request, then creates 96 a transaction registration entry and assigns a unique identifier (TID), and records 98 SPID, TID, and active connection information from a consumer service CS in entry TID.

The common directory service connects 101 to an IP address and port of SPSID, and the service process accepts 102 the connection. The common directory service then sends 103 the unique identifier (TID) to the service process. The service process receives 104 the unique identifier (TID), disconnects 105, and the common directory service disconnects 106. The service process connects 111 to the common directory service, the common directory service accepts 112 connection, and the service process sends 113 the unique identifier (TID) and SPID. The common directory service then receives 114 the unique identifier (TID) and SPID, locates 115 the transaction entry, and connects 116 the common directory service connection from service process to active connection from CS.

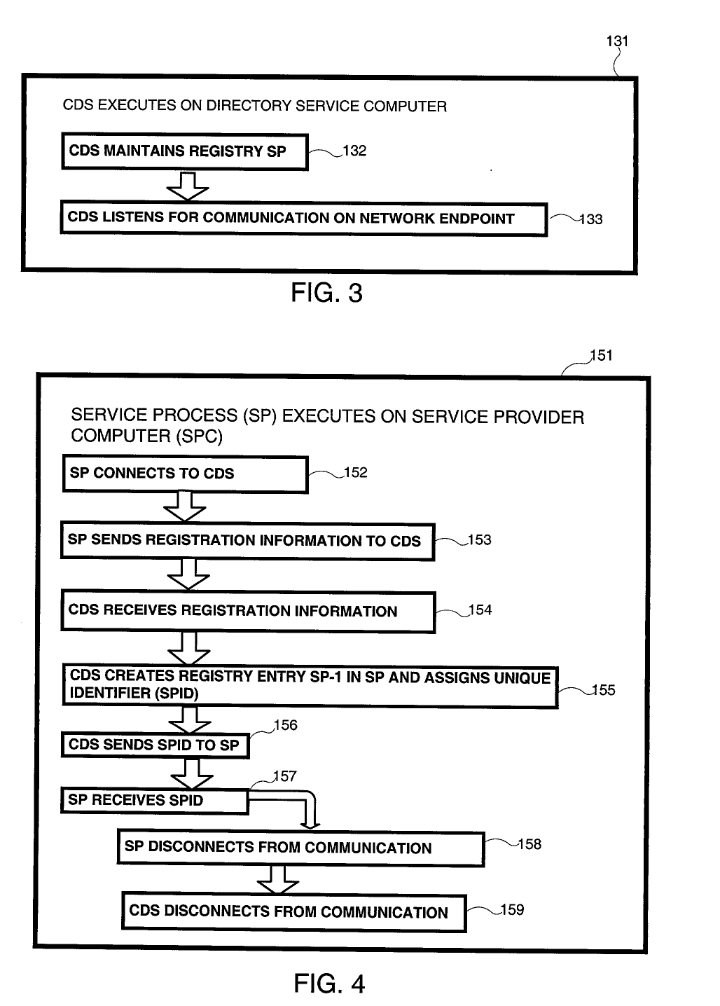

FIG. 3 is a flowchart of a directory service use. As can be seen, the common directory service executes 131 on the directory service computer (31, FIG. 1). The common directory service maintains 132 registry service process, and listens 133 for communication on network endpoint.

FIG. 4 is a flowchart of a service provider registration. A service process (SP) executes 151 on the service provider computer (32, FIG. 1), connects 152 to the common directory service, and sends 153 registration information to the common directory service. The common directory service receives 154 registration information, and creates 155 registry entry SP-1 in service process and assigns the unique identifier (SPID). The common directory service then sends 156 SPID to service process. The service process receives 157 SPID, disconnects 158 from communication, and the common directory service disconnects 159 from communication.

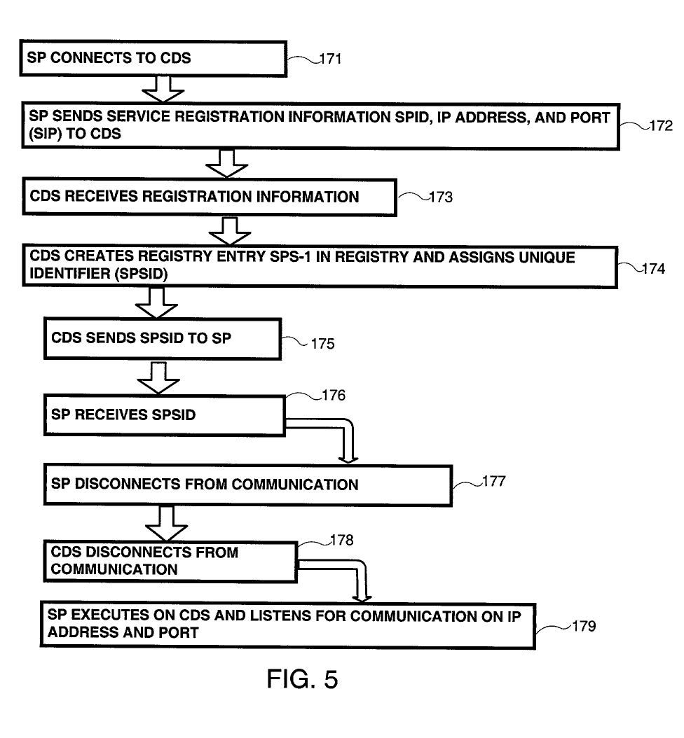

FIG. 5 is a flowchart of a service registration. The service process connects 171 to the common directory service, sends 172 service registration information SPID, IP address, and port (SIP) to the common directory service. The common directory service receives 173 registration information, creates 174 registry entry SPS-1 in registry and assigns the unique identifier (SPSID), and sends 175 SPSID to service process. The service process receives 176 SPSID and disconnects 177 from communication. The common directory service disconnects 178 from communication and the service process executes 179 on the common directory service and listens for communication on IP address and port

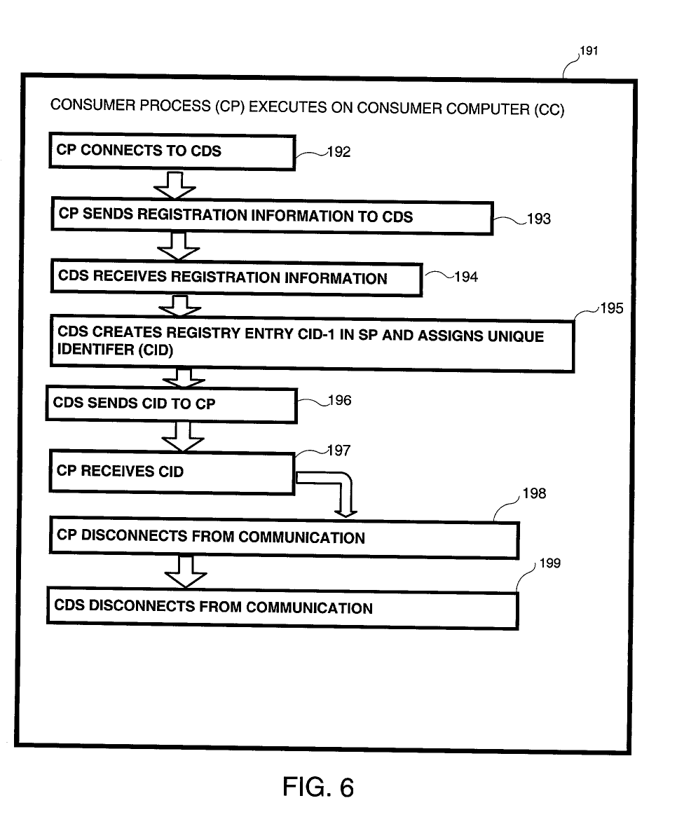

FIG. 6 is a flowchart of a consumer registration. A consumer process executes 191 on the consumer computer (33, FIG. 1), connects 192 to the common directory service, and sends 193 registration information to the common directory service. The common directory service then receives 194 registration information, creates 195 registry entry CID-1 in service process, assigns the unique identifier (CID), and sends 196 the CID to consumer process. The consumer process receives 197 the CID and disconnects 198 from communication, and the common directory service disconnects 199 from communication.

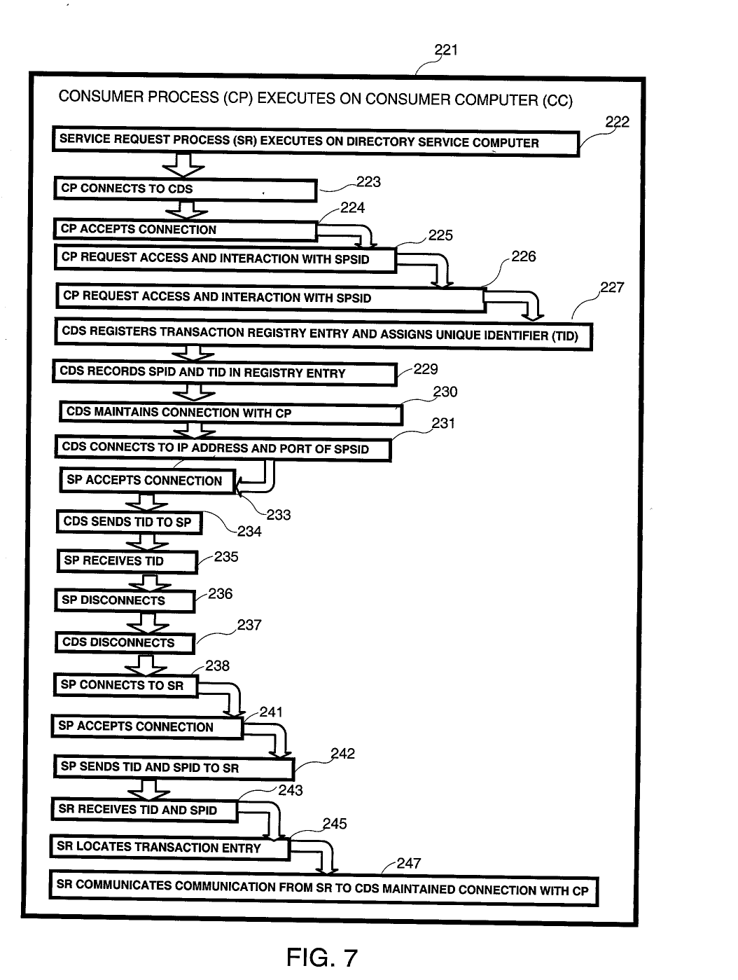

FIG. 7 is a flowchart of a consumer request for service. A consumer process executes 221 on consumer computer (33, FIG. 1). A service request process executes 222 on the directory service computer (31, FIG. 1). The consumer process connects 223 to the common directory service, and the common directory service accepts 224 the connection. The consumer process then requests 225 access and interaction with SPSID. The common directory service receives 226 the request and locates SPSID registry entry, registers 227 the transaction registry entry and assigns the unique identifier (TID), and records 229 the SPID and TID in registry entry. The common directory service maintains 230 the connection with consumer process, connects 231 to an IP address and port of the SPSID. The service process accepts 233 the connection and the common directory service sends 234 the unique identifier (TID) to the service process. The service process receives 235 the unique identifier (TID) and disconnects 236. The common directory service disconnects 237 and the service process connects 238 to the service request process. The service request process accepts 241 the connection, and the service process sends 242 the TID and SPID to the service request process. The service request process then receives 243 the TID and SPID, locates 245 a transaction entry, and communicates 247 communication from service request process to the common directory service maintained connection with consumer process.

In a preferred embodiment, a prototype table is created containing a msg indicator along with a flds indicator and a description of the columns for the table. The prototype table can also include one or more rows. The Daytona DC-rcd command can be used to generate the data dictionary information. For example, using “DC-rcd SERVICES>rcd.SERVICES” will generate the data dictionary information for us, without having to enter that information manually. Three examples of a service registries are given in Program Listings 16.1, 16.2 and 16.3, respectively. The command to generate the data dictionary is shown in Program Listing 16.4. The resulting generated data dictionary is shown in Program Listing 16.5. The Daytona Synop command can be used for data dictionary reporting. Alternatively, the backtalk command shipped with daytona can be used to generate data dictionary information.

Program Listing 16.6 shows a second embodiment of the service registry prototype table. Using the DC-rcd command, the data dictionary shown in Program Listing 16.7 is then generated. Similarly, the embodiment of a providers registry is shown in Program Listing 16.8, with the generated data dictionary in Program Listing 16.9. An embodiment to register an entry is given in Program Listing 16.10, while Program Listing 16.11 provides an embodiment to report registration entry information. The embodiment could use the Daytona Tracy command to process the Daytona query, which can understand either Cymbal, SQL, or a combination thereof.

Note that in Program Listing 16.12, the registration request is given as a Daytona task (also called a function/predicate/procedure, or fpp). Semantically, the idea is that there is some goal that a task is intended to achieve, and the code that is has for doing that is free to call its own private helper fpps as well as other tasks. Using Daytona's Tracy command, the fpp is converted to C source code, which can then be compiled into object code. In normal processing, the object code is then linked with the appropriate Daytona runtime objects and libraries to generate an executable program. Alternatively, the object code can be linked with other application object code to provide the fpp directly at the application level. By way of example, an application programmer can write their own source code which can then invoke the desired fpp by linking with the object code, and other Daytona runtime objects and libraries. In an alternative embodiment, an application process can use the invention to call the fpp by dynamically loading the fpp according to the specification of this invention. The application service, however, will need to ensure that the Daytona Sizup command is executed as appropriate to maintain the Daytona data files and indices. The use of the Daytona code synthesis (code generation) permits the administrative capabilities of registration, query, delete, modification, replication, reporting, and other such functionality as would be required in administering and managing the data, to be instrumented through the methods and systems of this specification.

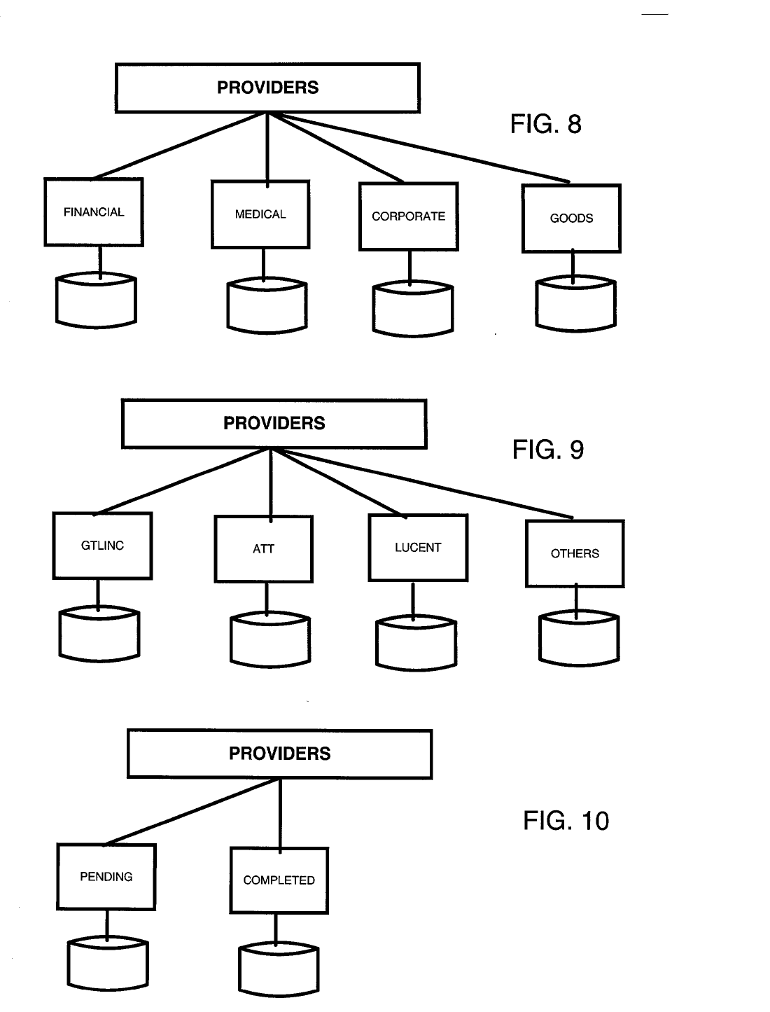

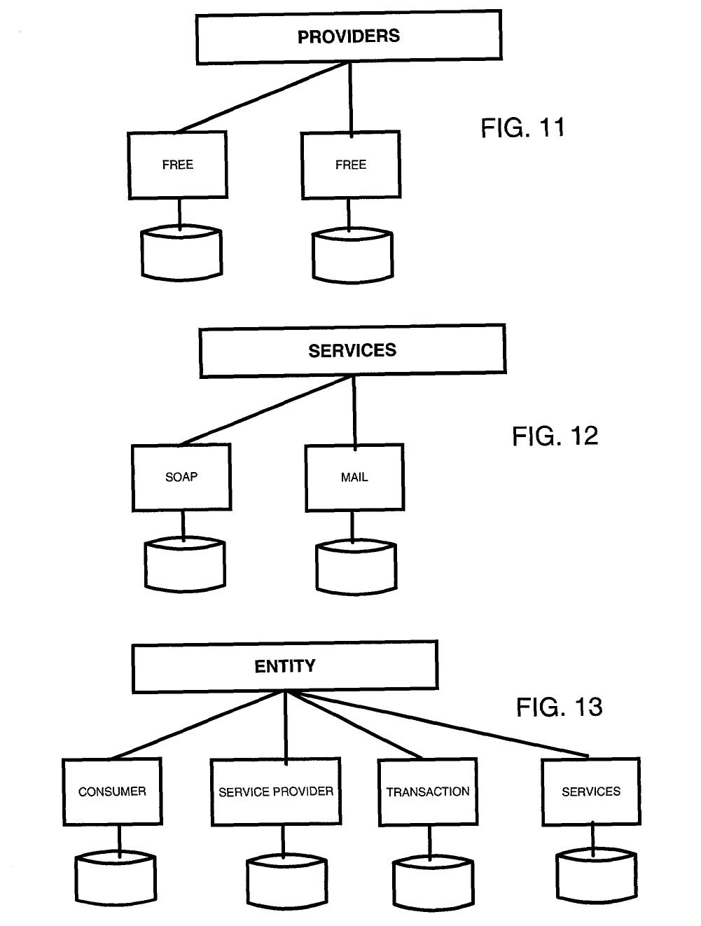

In an embodiment shown in FIG. 8, the service directory would be horizontally partitioned. A horizontal partition divides the rows of the service directory (registry) horizontally based on criteria and put each group in its own file. The resultant individual files will be easier to manage. Another benefit is that the physical field that would have previously been recorded in the registry can be eliminated, thus saving disk storage. In FIG. 8, the horizontal partition is the category of the service. In FIG. 9 the horizontal partition is based on the provider. In FIG. 10, the horizontal partition is based on the activity. In FIG. 11, the horizontal partition is based on the cost. In FIG. 12, the horizontal partition is based on the protocol. In FIG. 13, the horizontal partition is based on the entity type.

If the underlying data management system supports horizontal partitioning, then such partitioning techniques could be used as well.

The Directory Service

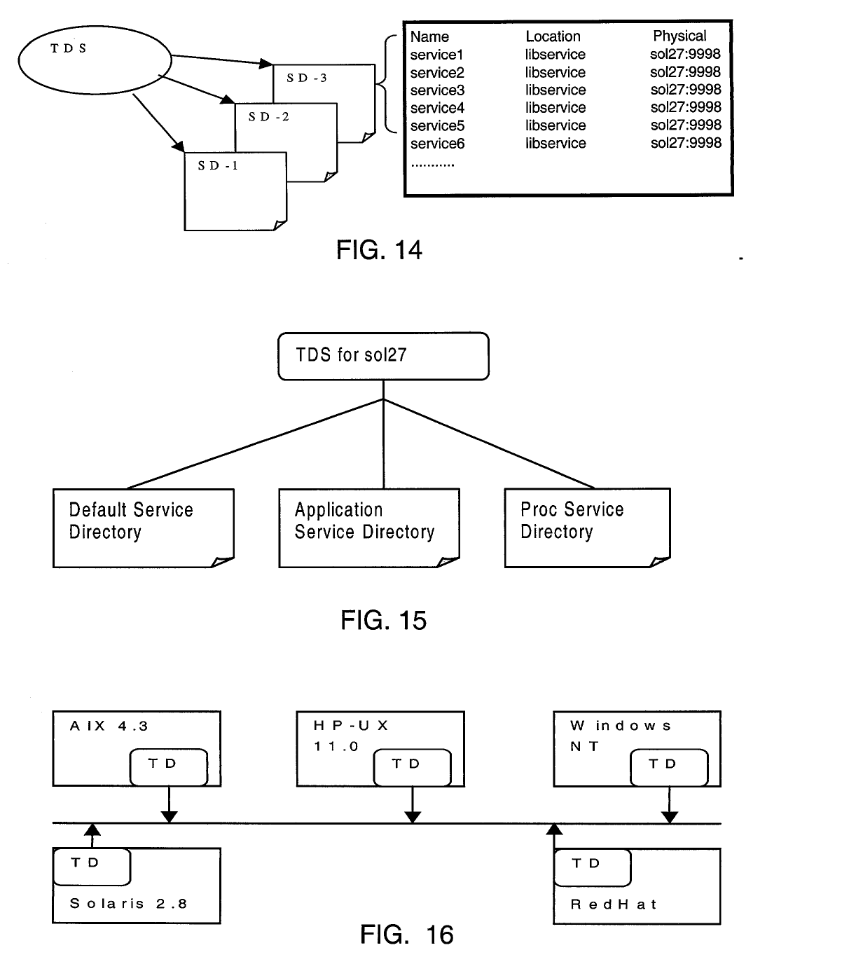

The Directory Service (TDS) can administer one or more Service Directories (SD). In the most primitive form, a Service Directory contains one or more entries representing entities providing a service. Each service directory is uniquely named. A service directory entry is comprised of one or more Information Components (IC) given as name/value pairs, as depicted in FIG. 14. The primitive operations for TDS include register, query, and delete. Additional administrative operations are supported, such as index, update, modify, and replicate.

FIG. 14 illustrates a typical TDS instance. In this illustration, there are three service directories being maintained by a single TDS process. FIGS. 15 and 16 are diagrams illustrating different implementations of TDS instances. FIG. 15 is a sample configuration for System sol27 (Solaris 2.7). FIG. 16 is a sample configuration using multiple operating systems and different OS implementations. In FIG. 16, three implementations of Unix, one implementation of Microsoft Windows and one implementation of Linux each have a TSD instance and are interconnected.

Different entities provide different types of services, although a single entity can provide a multitude of services. A component of software, for example, can provide some form of a service. The term component of software is deliberately chosen to imply that less then an entire executable program can still provide a service. Examples include objects from shared libraries, a specification for an interpretative language, a device, a process, and even a thread of execution. The operating system itself can be said to provide a service, or a multitude of services.

A service provided by a component of software can be registered in TDS. When needed, a separate process can cause the service to be started. “The Connection Service”, described in U.S. Pat. No. 5,850,518, describes one technique for registering components of a service.

A user can provide a service. Consider, for example, the Netscape Navigator, or Microsoft IE. Both of these programs require a user to enter a URL in order to determine what to display next. Thus, the user provides input and this is considered a service. Similarly, an email application stores email directed towards a specific user. Retrieving the email is considered a service.

Service providers provide services, and consumers consume services. A consumer, however, can also provide a service. Similarly, a service can also consume services.

In generalized terms, a service is facilitated by a process. For example, a spell checker is a process that provides a service. Similarly, a caching process can provide a service. The distinction of when a process is a service, and when it is a consumer, is relative to what the process is doing at a particular point in time.

In the context of TDS, a process can be heavyweight, medium-weight, or lightweight. A process can consist of multiple threads of execution, including kernel threads.

Each entity is referred to as a point of communication (compoint). To facilitate the method, each compoint can participate in a communication with another compoint. A compoint can either send a communication, receive a communication, or both send and receive communications. A communication can be sent as messages, data, and streams.

The generalization of services permits a single TDS to administer multiple service directories. This provides maximum flexibility in organizing service entries. Note, however, that multiple TDS processes can execute on the same system. Furthermore, remote TDS processes can broadcast their availability and this will cause the local TDS to register the remote as an entity providing a service.

In a typical environment, a system wide TDS is available as a compoint. The system wide TDS provides a default service directory for a specific system. Be careful not to confuse the term system wide with network wide, or corporate wide. The term system wide simply means a TDS that is executing on a single computer and is available to any compoint executing on that computer. The system wide TDS is also available for remote processes.

All request received that do not specify a particular service directory, will be executed against the default service directory. The default service directory contains one or more service type entries. Each entry is composed of one or more IC pairs (name/value pairs).

The system wide TDS can maintain multiple service directories. This permits the grouping of common service entries into a service directory dedicated to the service type. Each service directory has a unique identifier.

An example TDS is shown in figure TDS-2 for a system called sol27. In this example, TDS maintains a default service directory, an application services service directory, and a process service directory.

When TDS is started, it will broadcast its availability. This permits a TDS on one system to share information with a TDS on a second system. When a local TDS receives a broadcast from a remote TDS, the local TDS will query the remote TDS to learn its registered characteristics. As long as the characteristics can be determined, the local TDS will register the remote TDS in the local TDS's default service directory, as an entity providing a service.

An environment with 5 systems, each running their own TDS and sharing information is shown in figure TDS-3. Each of the TDS process's broadcast their availability.

Each service directory has a record-class-description (rcd) defining the IC pairs for the service type entry. Record class descriptions are described in more detail in section 2.2 and 2.3 of this document.

A service entry consists of multiple IC pairs. The service entry has an assigned the unique identifier. Each IC pair consists of a name and a value. The grammar is given as:

service type entry: id name=value [name=value] . . . [name=value]

A value can contain white space provided it is quoted. The following examples show various name/value pairs.

tds=default

tds=“system wide service directory”

tds=‘application specific service directory’

All entries within a given service directory must be unique. Uniqueness, however, can be a single IC pair. Thus, the following are considered unique entries:

name=tds physical=/local:/usr/lib/share/TDS/tds_compoint

name=tds physical=sol28:9998

name=tds physical=sol28:127.0.0.1:998

An IC name has attributes describing its use. A private attribute, for example, instructs TDS not to report the IC pair in a query operation.. The default public attribute, however, indicates that the IC pair is to be reported in query operations. Note that a query operation can use the IC name value pair as part of the criteria for selecting the entry, but TDS will not include that IC pair in the query response. A service directory can also be marked as private, and thus the name of the service directory will not appear in the results of query operations.

When a first rcd is replaced with a second rcd, the operation can specify a load map to map the existing entries according to the new rcd.

TDS permits IC pairs to be prefixed with their corresponding service directory identifier. For example, a query command can reference the name IC from the suppliers service directory and the name IC from the products service directory by specifying:

query supplier.name=“GTL.*” product.name=*”

A record class description (rcd) defines the characteristics of the IC pairs for a given service directory. Each service directory has a rcd.. The rcd defines the IC pairs and their data representation. An example rcd is given as:

| | |
|---|---|
| command=rcd | \ |

| | |
|---|---|
| sd=“applications” | \ |

| | |
|---|---|
| service_name=str(50) | \ |
| registration_date=yymmdd | \ |

| | |
|---|---|
| value=float | \ |
| count=int | \ |
| flag=short | \ |
| provider=str(*) | |

To impose a rcd, an administrative process must register the rcd with TDS when the service directory is created. Alternatively, a default rcd can be identified through the configuration file. A rcd can be inherited from a parent Service Directory.

When a process registers a service with TDS, then TDS will search for an applicable red and will invoke the corresponding red function. Similarly, when the process queries TDS for an accessible service, TDS will search for an applicable red and will invoke the corresponding red function.

When a service directory is referenced without an existing red, then TDS simply adds the IC pairs are necessary, to the service directory. As an example, the following register command will create the service directory process, and add the pid and uid IC pairs.

command=register sd=process pid=19452 uid=12345

This makes TDS lightweight enough for even the simplest of applications. Of course, once a service directory has been created in this fashion, you cannot add a record class description without applying some form of conversion.

It may be inappropriate to use TDS in this manner for production environments, as there is no provision for validating the registration. Using a record class description, however, will limit registration requests to only those IC pairs defined in the record class description. Additionally, indexing and data management is much more robust when a record class description is defined.

The primitive operations for TDS include register, query, and delete. Several additional operations are provided for administrative support. Each request to TDS includes a command, and one or more IC pairs, given as parameters. Examples include

command=register name=tds physical=/local:/usr/TDS/tds_compoint

command=register name=tds physical=sol28:127.0.0.1:998

command=query name=“*” action=match

command=query name=“this is a string” action=casecmp

Note that for query command, there is an implied AND operator between the IC pairs. Explicit Boolean operators are also supported. Support for Boolean operators is dependent on the rcd implementation.

The query operation will report all public IC pairs for the registered service. To limit the scope of the report, a special action IC pair can be used. Assigning a value of match to the action will cause query to report only those IC pairs specified as parameters to the query operation.. The special value of “*” for an IC pair, indicates to match anything.. Thus, the query operation below will report the all entries having a name=Jane and having an email IC component.

query name=“Jane” email=“*” action=match

Multiple action IC pairs can be specified. Valid actions include:

| | |
|---|---|
| strcasecmp | ignore case when comparing |
| numericcmp | use a numeric comparison instead of a ASCII comparison |

The query command supports regular expression pattern matching.. The following query will match on all entries with a name IC pair wherein the value starts with the letter J.

query name=“J*” email=“*” action=match

When using a query command against a single service directory, you can specify the service directory name with a sd parameter given as an IC pair. When using a query command to query multiple service directories, you can prefix the IC pair name with the name of the applicable service directory. Consider for example a service directory identified as suppliers, and a service directory identified as products.. The following queries are acceptable through TDS.

command=query sd=suppliers name=“Global Tech.*”

command=query suppliers.name=“Global Tech.*” products.name=uwin

command=query products.name=uwin

The first registration command, given below, creates a new service entry in the service directory.. The second registration command adds the IC pair primitive=INET to that entry.

command=register name=tds physical=sol28:9998

command=register name=tds physical=sol28:9998 primitive=INET

Using the register command, a process can register a NULL value for an IC pair, thus eliminating it from the service directory.. The service directory does not retain any NULL valued IC pairs. Consider, as an example, the following:

command=register name=tds physical=sol28:9998 pid=1956

command=register name=tds physical=sol28:9998 pid=

In this example, the first operation creates a service directory entry with name=tds physical=sol28:9998, and pid=1956.. The second operation then assigns a NULL value to pid, and thus pid is removed from the entry. (TDS silently discards NULL value IC pairs).

TDS supports the Cymbal 4th generation language in command statements.. The format is:

command=DS spec=specification

TDS provides administrative services for authentication and communication encryption. Administrative services are dynamically re-configurable, and provide sufficient flexibility to meet most needs.

The authentication service provides for authentication of requesting processes.. The unscramble service provides unscrambling (decryption) of communicated data, and the scramble service offers scrambling (encryption) of communicated responses.

Administrative services can be registered for a particular service directory, and default to administrative services registered for the system wide service directory. Administrative services can be limited to particular primitives, such as the register primitive, or, registered for all primitives.

To register an administrative service for a service directory, you must specify the service and the service directory to which it applies. For example:

command=register service=authentication\

sd=default name=default_logging location=libservices.so.1.0 physical=—

To register an administrative service for a particular primitive within a service directory, you would specify the primitive, the service, and the service directory. For example:

command=register primitive=register service=authentication\

sd=default name=default_logging location=libservices.so.1.0 physical=—

Registered administrative services are retained by TDS through the backed data management system.

Note that the user id of the process that started TDS can replace or otherwise alter the registered administrative services.. Thus, the user id becomes the administrator of TDS.

The authentication service, if registered, is provided with connection information indicating the system from which the requesting process originates, and possibly the process identifier.. The authentication service provides a status result, which if zero, indicates that authentication is successful. Otherwise, authentication fails and the connection is closed.

The unscramble service, if registered, is provided with the content.. The unscramble service will unscramble the content and provide a response which is then used for subsequent operations. As implied, the entire message received by TDS cannot be scrambled.. The reason is that TDS must be able to ascertain the service directory component, and possibly the command component IC pairs in order to determine the appropriate unscramble service.

The scramble service, if registered, is provided with the response communication.. The service will scramble the content, and provide the response to TDS, which then makes it available to the requesting process.

TDS can be started from /etc/rc services, or, by any application having appropriate privilege.. The first call to TDS will create a default system wide service directory for general registration.. The system wide SD can be disabled by changing the systemSD=default to systemSD=none, in the TDS configuration file. See the section Configuring TDS for more details.

TDS is configured to recognize and process a set of commands. Nonetheless, a process can register new commands, alter existing commands, and change the behavior of commands. A command is sent to TDS as a name/value pair, with one or more parameters given as IC pairs. Note that IC pairs command=value and tds=value are non-alterable and processed by TDS.. The remainder of the IC pairs are given as parameters to the service corresponding to the command. TDS uses the tds=value IC component to select the appropriate registry service directory. Once located, the register service is called with a reference to the service directory, and the remainder of the IC pairs given as parameters.

command=register

[tds=service directory]

[name=value]

command=query

[tds=service directory]

[name=value]

command=delete

[tds=service directory]

[name=value]

command=register

rcd=rcd

[tds=service directory]

[location=rcd service location]

[physical=physical connectivity]

[inheritence=on|off]

command=delete

rcd=rcd_name

tds=service directory

TDS provides a registration feature for service such that the administrator of the service directory can register alternative primitive commands.. This includes the register, query, and delete primitives. In registering an alternative command, TDS will change to the owner user identifier during the request.. Thus, if TDS is started by a first user id, and an authorized process registers an alternative query command, then TDS will set the effective user id to the authorized process user id prior to executing the command.. This option can be disabled through the TDS configuration file.

TDS also permits registration of additional primitives beyond the standard TDS primitives. When TDS receives a command, it will look-up the command name, and execute the specified registered command. To ensure security, however, TDS will temporarily switch to the specified user id when executing the specified command.. This option can be disabled through the TDS configuration file.

In our network, we provide a supplier service directory and an applications service directory as the default directory services offered through TDS.. The supplier service directory records all suppliers of services while the applications service directory records available application services.. The record class descriptions are given as:

rcd=Supplier sd=Suppliers
Name=string(50) Address=string(50) City=string(20)
State=string(3) Zip=string(10) Contact=string(20)
Phone=string(10) Id=string(15)
rcd=Applications sd=Applications
Name=string(20) Location=string(256) Physical=string(25)
Primitive=string(10) System=string(15) Release=string(5)
Os=string(15) Description=string(250) Id=string(15)
The following services are then registered on the sol27 system.
command=register sd=Suppliers
Name=“GTL Inc” Address=“15 Spring St” City=Princeton

State=NJ

| Zip=08542 Contact=sales Phone=(609)924-7305 | | |
|---|---|---|
| Id=123456789 | | |
| command=register sd=Applications | | |
| Id=123456789 | Name=queued | Location=services |
| Physical=sol27:9990 | Primitive=inet | System=sol27 |

Os=solaris Description=“queue service”

command=register sd=Suppliers
Name=“GTL Inc” Address=“15 Spring St” City=Princeton

State=NJ

Zip=08542 Contact=sales
Phone=(609)924-7305 Id=123456789
command=register sd=Applications
Id=123456789 Name=url_pe Location=services
Physical=*:* Primitive=inet System=winntsp6
Os=“Windows NT” Description=“URL Processing Element”

Similarly, for the redhat6.1 system we register:

command=register sd=Suppliers
Name=“GTL Inc” Address=“15 Spring St” City=Princeton

State=NJ

Zip=08542 Contact=sales Phone=(609)924-7305
Id=123456789
command=register sd=Applications
Supplierid=123456789 Name=url_pe Location=services
Physical=*:* Primitive=inet System=winntsp6
Os=“Red Hat Linux” Description=“URL Processing Element”

Once the service entries have been registered, our rcd functions record the entries into indexed files for subsequent retrieval.

On the sol27 system, we execute a urld process.. This process fetches an HTML page from the Internet, and stores that page on the local system.

The urld process will query TDS to locate an available url_pe service to process the fetched page.

Program Listing 1.1 Source Code Listing of One Implementation for the Replacement recv Function

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed:

1. In a network comprised of a multiplicity of computers, each computer having a communication device, each computer having an operating system with interfaces for communication connectivity and synchronization, a method for using a service, the method comprising:
a. a first component of software executing on a first computer and registering as a specified service with a directory service process executing on a second computer;
b. the directory service process creating a registration for the first component of software;
c. a second component of software executing on a third computer and communicating a request to the directory service process, the request representative of a request to access and interact with the specified service provided by the first component of software;
d. the directory service process, responsive to receiving the request, locating the registration entry for the first component of software, and facilitating communication with the first component of software on behalf of the second component of software.

2. The method of claim 1 wherein the specified service is a software engine service.

3. The method of claim 1 wherein the specified service is an authentication service.

4. The method of claim 1 wherein the specified service is a generic front end loading service.

5. The method of claim 1 wherein the specified service is a payment connection service.

6. The method of claim 1 wherein the specified service is a data sharing service.

7. The method of claim 1 wherein the specified service is a medical test results reporting service

8. The method of claim 1 wherein the specified service is a data store forwarding service.

9. The method of claim 1 wherein the specified service is a physician pharmaceutical service.

10. The method of claim 1 wherein the specified service is an academic transcript service.

11. The method of claim 1 wherein the specified service is a public office election service.

12. The method of claim 1 wherein the specified service is a medical records service.

13. The method of claim 1 wherein the specified service is a resume matching service.

14. The method of claim 1 wherein the specified service is a company credit reporting service.

15. The method of claim 1 wherein the specified service is a prepay service.

16. The method of claim 1 wherein the specified service is a translation service.

17. The method of claim 1 wherein the specified service is an environment service.

18. Computer readable media containing computer instructions implementing the method of claim 1.

19. In a network comprised of a multiplicity of computers, each computer having a communication device, each computer having an operating system with interfaces for communication connectivity and synchronization, a method for using a service, the method comprising:
a. a first component of software executing on a first computer and registers as a specified service with a directory service process executing on a second computer;
b. the directory service process creating a registration entry in a registry for the specified service;
c. a second component of software executing on a third computer and communicating a request to the directory service process, the request representative of a request to communicate with the specified service provided by the first component of software;
d. the directory service process, responsive to receiving the request, locating the registration entry for the first component of software, and creating a transaction in progress registration entry, the transaction entry having a transaction the unique identifier;
e. the directory service process connects to specified service provided by first component of software and communicating the transaction the unique identifier;
f. the specified service receiving the transaction the unique identifier and both the directory service process and the specified service disconnect from the communication;
g. the specified service connects to the directory service and communicating the transaction the unique identifier; and
h. the directory service, responsive to receiving the transaction the unique identifier, connects the specified service to the second component of software.

20. Computer readable media containing computer instructions implementing the method of claim 1.
